(19) United States
(12) Patent Application Publication
(10) Pub. No.: US 2026/0124936 A1
(43) Pub. Date: May 7, 2026

(54) ARCHITECTURE FOR FUEL CELL MINING TRUCKS

(71) Applicant: Cummins Inc., Columbus, IN (US)

(72) Inventor: Kieran J. Richards, Northamptonshire (GB)

(21) Appl. No.: 18/934,857

(22) Filed: Nov. 1, 2024

(51) Int. Cl. B60L 50/71; B60L 50/60; B60L 50/75

(52) U.S. Cl. CPC B60L 50/71; B60L 50/66; B60L 50/75; B60L 2200/36; B60L 2200/40

(57) ABSTRACT

Architectures of heavy equipment vehicles, such as mining trucks, are presented herein for hybridization of such vehicles. For example, the architectures provided herein may relate to the placement of fuel cell stacks, battery packs, fuel tanks, and/or other related components within an existing or new architecture of a heavy equipment vehicle.

### TECHNICAL FIELD OF THE PRESENT DISCLOSURE

The present disclosure relates to architectures, or component arrangement, of fuel cell mining trucks. In particular, the present disclosure relates to the arrangement of vehicle components for the retrofitting or first fitting of mining trucks for operation of the mining trucks using fuel cell powertrain systems.

### BACKGROUND OF THE PRESENT DISCLOSURE

Environmental and efficiency considerations has resulted in the electrification of vehicles across industries and purposes. While electric and hybrid passenger and cargo vehicles are becoming more commonplace, electrification and/or hybridization of large equipment vehicles poses its own set of challenges. For example, large equipment vehicles, such as mining trucks, cranes, bulldozers, etc. may require a workload and/or have a sheer size component that make implementation of alternative powertrains more difficult. Additionally, the components required for hybridization and/or electrification of such vehicles may be difficult to arrange due to the space available relative to the respective vehicle for mounting such components.

### SUMMARY OF THE PRESENT DISCLOSURE

Architectures of heavy equipment vehicles, such as mining trucks, are presented herein for hybridization of such vehicles. For example, the architectures provided herein may relate to the placement of fuel cell modules, battery pack modules, fuel tanks, and/or other related components within an existing or new architecture of a heavy equipment vehicle.

In a first aspect of the disclosure a mining haul truck is provided. The mining haul truck includes a vehicle chassis having a first end portion with a first end and a second end portion with a second end. The vehicle chassis includes a first longitudinal member extending from the first end to the second end and a second longitudinal member extending from the first end to the second end. The first longitudinal member and the second longitudinal member define a vehicle chassis space therebetween. A first wheel is coupled to the first longitudinal member at a first forward position. A second wheel is coupled to the first longitudinal member at a first rearward position. The first wheel and the second wheel define a side saddle therebetween. A third wheel is coupled to the second longitudinal member at a second rearward position. The third wheel and the fourth wheel define a second side saddle therebetween. A power module support frame is coupled to a forward position of the vehicle chassis. A first fluid tank is positioned within the vehicle chassis space defined by the first longitudinal member and the second longitudinal member and supported by the power module support frame.

In another aspect of the disclosure, a mining haul truck is provided. The mining haul truck includes a vehicle chassis having a first end portion with a first end and a second end portion with a second end. The vehicle chassis includes a first longitudinal member extending from the first end to the second end and a second longitudinal member extending from the firs tend to the second end. The first longitudinal member and the second longitudinal member define a vehicle chassis space therebetween. A power module support frame is coupled to a forward position of the vehicle chassis. A first fluid tank is positioned within the vehicle chassis space defined by the first longitudinal member and the second longitudinal member and mounted to a lower portion of the power module support frame. A fuel cell module is positioned within the vehicle chassis space and supported by an upper portion of the power module support frame. A balance-of-plant module is positioned within the vehicle chassis space and supported by the upper portion of the power module support frame.

In yet another aspect of the disclosure, a mining haul truck is provided. The mining haul truck includes a vehicle chassis having a first end portion with a first end and a second end portion with a second end. The vehicle chassis includes a first longitudinal member extending from the first end to the second end and a second longitudinal member extending from the first end to the second end. The first longitudinal member and the second longitudinal member define a vehicle chassis space therebetween. A power module support frame is positioned within the vehicle chassis space and coupled to the vehicle chassis. A first battery module is supported by the power module support frame. A first fuel cell module is positioned within the vehicle chassis space and supported by the power module support frame in a vertical arrangement with the first battery module so that the first fuel cell module is positioned above the first battery module. A first balance-of-plant module is positioned on the power module support frame and operably connected to the first fuel cell module.

In another aspect of the disclosure, a mining haul truck is provided. The mining haul truck includes a vehicle chassis having a first end portion with a first end and a second end portion with a second end. The vehicle chassis includes a first longitudinal member extending from the first end to the second end and a second longitudinal member extending from the first end to the second end. The first longitudinal member and the second longitudinal member define a vehicle chassis space therebetween. A power module support frame is positioned within the vehicle chassis space and coupled to the vehicle chassis. A fuel cell module is positioned within the vehicle chassis space and supported by the power module support frame. A balance-of-plant module is positioned within the vehicle chassis space, connected to the fuel cell module, and supported by the power module support frame. A radiator is positioned within the vehicle chassis space and supported by the power module support frame. The radiator is positioned in a vertical arrangement with the fuel cell module and the balance-of-plant module so that the radiator is positioned above the fuel cell module and the balance-of-plant module.

In yet another aspect of the disclosure, a mining haul truck is provided. The mining haul truck includes a vehicle chassis having a first end portion with a first end and a second end portion with a second end. The vehicle chassis has a first longitudinal member extending from the first end portion to the second end portion and a second longitudinal member extending from the first end portion to the second end portion. The first longitudinal member and the second longitudinal member define a vehicle chassis space therebetween. A first wheel is coupled to the first longitudinal member at a forward position. A second wheel is coupled to the first longitudinal member at a rearward position. The first wheel and the second wheel define a side saddle therebetween. A deck is supported by the first end portion of the vehicle chassis. A battery module is positioned within the first end portion of the vehicle chassis adjacent the first end of the vehicle chassis.

In another aspect of the disclosure, a mining haul truck is provided. The mining haul truck includes a vehicle chassis having a first end portion with a first end and a second end portion with a second end. The vehicle chassis including a first longitudinal member extending from the first end to the second end and a second longitudinal member extending from the first end to the second end. The first longitudinal member and the second longitudinal member define a vehicle chassis space therebetween. A power module support frame is positioned within the vehicle chassis space and coupled to the vehicle chassis. A first battery module is supported by the power module support frame. A second battery module is positioned at the first end portion of the vehicle chassis adjacent the first end of the vehicle chassis.

In yet another aspect of the disclosure, a mining haul truck is provided. The mining haul truck includes a vehicle chassis having a first end portion with a first end and a second end portion with a second end. The vehicle chassis includes a first longitudinal member extending from the first end portion to the second end portion and a second longitudinal member extending from the first end portion to the second end portion. The first longitudinal member and the second longitudinal member define a vehicle chassis space therebetween. A first wheel is coupled to the first longitudinal member at a first forward position. A second wheel is coupled to the first longitudinal member at a first rearward position. The first wheel and the second wheel define a first side saddle therebetween. A third wheel is coupled to the second longitudinal member at a second forward position. A fourth wheel is coupled to the second longitudinal member at a second rearward position. The third wheel and the fourth wheel define a second side saddle therebetween. The second wheel and the fourth wheel define a rear chassis space therebetween. A fluid tank is mounted at the first end portion of the vehicle chassis adjacent to the first end of the vehicle chassis.

In another aspect of the disclosure, a method of assembling a mining haul truck is provided. The mining haul truck has a vehicle chassis including a first longitudinal member extending from a first end of the vehicle chassis to a second end of the vehicle chassis. The method includes mounting a first battery module on a power module support frame within a vehicle chassis space defined between the first longitudinal member and the second longitudinal member. The method also includes positioning a first fuel cell module in a vertical arrangement with the first battery module so that the first fuel cell module is supported by the power module support frame above the first battery module.

In yet another aspect of the disclosure, a method of assembling a mining haul truck is provided. The mining haul truck has a vehicle chassis including a first longitudinal member extending from a first end of the vehicle chassis to a second end of the vehicle chassis and a second longitudinal member extending from a first end of the vehicle chassis to a second end of the vehicle chassis. The method includes mounting a fuel cell module to a power module support frame within a vehicle chassis space defined between the first longitudinal member and the second longitudinal member. The method also includes mounting a balance-of-plant module to the power module support frame and positioning a radiator in a vertical arrangement with the fuel cell module and the balance-of-plant module so that the radiator is supported by the power module support frame above the fuel cell module and the balance-of-plant module.

In another aspect of the disclosure, a method of assembling a mining haul truck. The mining haul tuck includes a vehicle chassis with a first end portion with a first end and a second end portion with a second end. The vehicle chassis includes a first longitudinal member extending from the first end portion to the second end portion and a second longitudinal member extending from the first end portion to the second end portion. A vehicle chassis space is defined between the first longitudinal member and the second longitudinal member. The mining haul truck also has a first wheel coupled to the first longitudinal member at a forward position and a second wheel coupled to the first longitudinal member at a rearward position. A side saddle is defined between the first wheel and the second wheel. A deck is supported by the first end portion of the vehicle chassis. The method includes mounting a battery module to the first end portion of the vehicle chassis adjacent to the first end of the vehicle chassis.

In yet another aspect of the disclosure, a method of assembling a mining haul truck is provided. The mining haul truck has a vehicle chassis including a first longitudinal member extending from a first end of the vehicle chassis to a second end of the vehicle chassis and a second longitudinal member extending from the first end of the vehicle chassis to the second end of the vehicle chassis. The first end of the vehicle chassis supports a deck. The method includes mounting a first battery module to a power module support frame. The power module support frame is coupled to the vehicle chassis within a vehicle chassis space defined between the first longitudinal member and the second longitudinal member. The method also includes mounting a second battery module at a first end portion of the vehicle chassis adjacent to the first end of the vehicle chassis.

In another aspect of the disclosure, a method of assembling a mining haul truck is provided. The method includes mounting a power module support frame to a forward portion of a vehicle chassis of the mining haul truck. The vehicle chassis includes a first longitudinal member extending from a first end of the vehicle chassis to a second end of the vehicle chassis and a second longitudinal member extending from the first end of the vehicle chassis to the second end of the vehicle chassis. The method also includes positioning a first fluid tank within a vehicle chassis space defined between the first longitudinal member and the second longitudinal member so that the first fluid tank is supported by the power module support frame. The mining haul truck further includes a deck supported by a first end portion of the vehicle chassis associated with the first end of the vehicle chassis; a first wheel coupled to the first longitudinal member at a first forward position; a second wheel coupled to the first longitudinal member at a first rearward position; a third wheel coupled to the second longitudinal member at a second forward position; and a fourth wheel coupled to the second longitudinal member at a second rearward position. The first wheel and the second wheel define a first side saddle therebetween. The third wheel and the fourth wheel define a second side saddle therebetween.

In yet another aspect of the disclosure, a method of assembling a mining haul truck is disclosed. The mining haul truck includes a vehicle chassis having a first end portion including the front end of the mining haul truck and a second end portion including a rear of the mining haul. The vehicle chassis includes a first longitudinal member extending from the first end portion to the second end portion and a second longitudinal member extending from the first end portion to the second end portion. The first longitudinal member and the second longitudinal member define a vehicle chassis space therebetween. A first wheel is coupled to the first longitudinal member at a first forward position. A second wheel is coupled to the first longitudinal member at a first rearward position. The first wheel and the second wheel define a first side saddle therebetween. A third wheel is coupled to the second longitudinal member at a second forward position. A fourth wheel is coupled to second longitudinal member at a second rearward position. The third wheel and the fourth wheel defined a second side saddle therebetween. The second wheel and the fourth wheel define a rear chassis space therebetween. The method includes mounting a fluid tank at the first end portion of the vehicle chassis adjacent to the first end of the vehicle chassis.

In another aspect of the disclosure, a mining haul truck is provided. The mining haul truck includes a vehicle chassis having a first end portion with a first end and a second end portion with a second end. The vehicle chassis includes a first longitudinal member extending from the first end to the second end and a second longitudinal member extending from the first end to the second end. The first longitudinal member and the second longitudinal member define a vehicle chassis space therebetween. A deck is supported by the first end portion of the vehicle chassis. An air inlet assembly is mounted to the deck. The air inlet assembling includes an air inlet scoop positioned above the deck and an air filter positioned in the air inlet scoop.

In yet another aspect of the disclosure, a method of assembling a mining haul truck is provided. The mining haul truck includes a vehicle chassis having a first end portion with a first end and a second end portion with a second end. The vehicle chassis includes a first longitudinal member extending from the first end to the second end and a second longitudinal member extending from the first end to the second end. The first longitudinal member and the second longitudinal member define a vehicle chassis space therebetween. The mining haul truck further includes a deck supported by the first end portion of the vehicle chassis. The method includes mounting an air inlet assembly to the deck. The air inlet assembly includes an air inlet scoop positioned above the deck. The method also includes positioning an air filter in the air inlet scoop.

In another aspect of the disclosure, a fuel cell module arrangement is provided. The fuel cell module arrangement includes a first battery module coupled to a top surface of a power module support frame; a first fuel cell module positioned above the first battery module; and a first balance-of-plant module coupled to a top surface of the power module support frame adjacent the first battery module. The first fuel cell module has a first connection end facing a first direction. The first balance-of-plant module is operably connected to the first connection end of the first fuel cell module.

In various aspects of the disclosure, the mining haul truck may include a hydraulic fluid tank positioned in the second side saddle and mounted to the vehicle chassis. The first battery module may be positioned between the power module support frame and the fluid tank.

In various aspects of the disclosure, the mining haul truck may include a fuel cell module positioned in one of the first side saddle and the second side saddle. The fuel cell module may be coupled to the vehicle chassis. The mining haul truck may include a battery module positioned in the other of the first side saddle and the second side saddle and coupled to the vehicle chassis.

In various aspects of the disclosure, the mining haul truck may include a battery module positioned within the vehicle chassis space and supported by the power module support frame.

In various aspects of the disclosure, the mining haul truck may include a battery module positioned within the first end portion of the vehicle chassis on or adjacent to the first end of the vehicle chassis.

In various aspects of the disclosure, the mining haul truck may include a battery module positioned in one of the first side saddle and the second side saddle and mounted to the vehicle chassis.

In various aspects of the disclosure, the mining haul truck may include a fuel cell module positioned in the second side saddle and coupled to the vehicle chassis.

In various aspects of the disclosure, the mining haul truck may include a fuel cell module positioned within the vehicle chassis space adjacent to the first fluid tank. The fuel cell module may be positioned between the power module support frame and the fluid tank. The fuel cell module may be in a vertical arrangement with the first fluid tank so that the fuel cell module is arranged above the first fluid tank.

In various aspects of the disclosure, the mining haul truck may include a fuel cell module positioned in the first side saddle and mounted to the vehicle chassis.

In various aspects of the disclosure, the mining haul truck may include a deck supported by the first end portion of the vehicle chassis; and a balance-of-plant module supported by the deck. The mining truck may include an air cleaner supported by the balance-of-plant module.

In various aspects of the disclosure, the mining haul truck may include a balance-of-plant module positioned within the vehicle chassis space and supported by at least one of the power module support frame and the first fluid tank. The balance-of plant module may be positioned between the power module support frame and the first fluid tank. The balance-of-plant module may be positioned in a rearward position relative to the fluid tank.

In various aspects of the disclosure, the mining haul truck may include an air cleaner positioned within the vehicle chassis space and supported by at least one of the power module support frame and the first fluid tank. The air cleaner may be supported by a balance-of-plant module. The balance-of-plant module may be supported by one of the power module support frame and the first fluid tank.

In various aspects of the disclosure, the first fluid tank may contain one of methanol and ammonia.

In various aspects of the disclosure, the first fluid tank may be a hydrogen tank.

In various aspects of the disclosure, the mining haul truck may include a second fluid tank positioned within one of the first side saddle, the second side saddle, and adjacent to the first fluid tank in the vehicle chassis space. The second fluid tank may be positioned adjacent to the first fluid thank within the vehicle chassis space. The first fluid tank and the second fluid tank may be in a vertical arrangement. The mining haul truck may include a third fluid tank positioned within another one of the first side saddle, the second side saddle, and adjacent to the first fluid tank in the vehicle chassis space. The first fluid tank may contain a first fluid and the second fluid tank may contain a second fluid different than the first fluid.

In various aspects of the disclosure, the mining haul truck may include a radiator positioned at the first end portion of the vehicle chassis adjacent the first end of the vehicle chassis. The radiator may be hingedly coupled to the mining haul truck. The mining haul truck may include a plurality of fans positioned between the radiator and the first fluid tank.

In various aspects of the disclosure, the mining haul truck may include a deck supported by a first end portion of the vehicle chassis; and an air cleaner supported by the deck adjacent to the first end of the chassis.

In various aspects of the disclosure, the mining haul truck may include a deck supported by a first end portion of the vehicle chassis and a resistor grid supported by the deck.

In various aspects of the disclosure, the mining haul truck may include a deck supported by a first end portion of the vehicle chassis and an inverter cabinet supported by the deck.

In various aspects of the disclosure, the first fluid tank may be cylindrical.

In various aspects of the disclosure, the mining haul truck may include a DC/DC system positioned in the vehicle chassis space in a vertical arrangement with the first fluid tank so that the DC/DC system is above the fluid tank.

In various aspects of the disclosure, the mining haul truck may include a rear chassis space defined between the second wheel and the fourth wheel and a heat exchanger positioned in the rear chassis space.

In various aspects of the disclosure, the mining haul truck may include a deck supported by a first end portion of the vehicle chassis. The deck may define an access panel to selectively provide access to the vehicle chassis space.

In various aspects of the disclosure, the mining haul truck may include a heat exchanger positioned within the first end portion of the vehicle chassis adjacent to the front end of the vehicle chassis.

In various aspects of the disclosure, the mining haul truck may include a first wheel coupled to the first longitudinal member at a first forward position and a second wheel coupled to the first longitudinal member at a first rearward position. The first wheel and the second wheel may define a side saddle therebetween. A battery module may be positioned within the first side saddle and mounted to the vehicle chassis. The mining haul truck may include a third wheel coupled to the second longitudinal member at a second forward position and a fourth wheel coupled to the second longitudinal member at a second rearward position. The third wheel and the fourth wheel may define a second side saddle therebetween. A hydraulics tank may be positioned within the second side saddle and mounted to the vehicle chassis. A second fluid tank may be positioned within the second side saddle and mounted to the vehicle chassis. At least one of the first fluid tank and the second fluid tank may be a hydrogen tank. At least one of the first fluid tank and the second fluid tank may contain one of methanol and ammonia.

In various aspects of the disclosure, the mining haul truck may include a deck supported by the first end portion of the vehicle chassis and an air cleaner supported by the deck.

In various aspects of the disclosure, the mining haul truck may include a first wheel coupled to the first longitudinal member at a forward position and a second wheel coupled to the first longitudinal member at a rearward position. The first wheel and the second wheel may define a side saddle therebetween. A fluid tank may be positioned within the first side saddle and coupled to the first longitudinal member. The fluid tank may contain one of methanol and ammonia. The fluid tank may be a hydrogen tank.

In various aspects of the disclosure, the mining haul truck may include a second battery module positioned within the vehicle chassis space and supported by the power module support frame. A second fuel cell module may be positioned within the vehicle chassis space and supported by the power module support frame in a vertical arrangement with the second battery module so that the second fuel cell module is positioned above the second battery module. A second balance-of-plant module may be positioned within the vehicle chassis space, supported by the power module support frame, and connected to the second fuel cell module. The first battery module may be coupled to a top surface of the power module support frame. The second battery module may be coupled to a bottom surface of the power module support frame.

In various aspects of the disclosure, the first balance-of-plant module may be integrated with the first fuel cell module.

In various aspects of the disclosure, the first balance-of-plant module may be spaced apart from the first fuel cell module. The first balance-of-plant module may be positioned at a forward position relative to the first fuel stack.

In various aspects of the disclosure, the mining haul truck may include a deck supported by the first end portion of the vehicle chassis; and a radiator positioned adjacent a forwardmost position of the deck. The mining haul truck may include a plurality of fans positioned adjacent to the radiator. The mining haul truck may include an air cleaner positioned between the radiator and the first balance-of-plant module.

In various aspects of the disclosure, the mining haul truck may include a battery module positioned at a first end portion of the vehicle chassis adjacent the first end of the vehicle chassis.

In various aspects of the disclosure, the mining haul truck may include an air cleaner positioned at a first end portion of the vehicle chassis adjacent the first end of the vehicle chassis.

In various aspects of the disclosure, the mining haul truck may include a plurality of fans positioned adjacent to the radiator.

In various aspects of the disclosure, the mining haul truck may include a fluid tank positioned within the side saddle and coupled to the vehicle chassis. The fluid tank may contain one of methanol and ammonia. The fluid tank may be a hydrogen tank.

In various aspects of the disclosure, the mining haul truck may include an air cleaner positioned within the first end portion of the vehicle chassis adjacent the first end of the vehicle chassis.

In various aspects of the disclosure, the mining haul truck may include a fuel cell module positioned within the vehicle chassis space. The mining haul truck may include a balance-of-plant module connected to the fuel cell module and positioned within the vehicle chassis space. The mining haul truck may include a radiator positioned in a vertical arrangement with the fuel cell module and the balance-of-plant module so that the radiator is above the fuel cell module and the balance-of-plant module. The radiator may be angled relative to the fuel cell module to define a triangular space between the fuel cell module and the radiator. The angle defined between the radiator and the fuel cell module may be 30°-45°. The mining haul truck may include a plurality of fans positioned adjacent to the radiator. The mining haul truck may include a second battery module positioned within the vehicle chassis space. The mining haul truck may include a hydrogen tank positioned in vertical arrangement with the second battery module so that the hydrogen tank is above the second battery module.

In various aspects of the disclosure, the mining haul truck may include a fluid tank positioned within the vehicle chassis space. The fluid tank may contain one of methanol and ammonia. The fluid tank may be a hydrogen tank.

In various aspects of the disclosure, the mining haul truck may include a balance-of-plant module supported by the deck. The mining haul truck may include a fluid tank positioned within the vehicle chassis space.

In various aspects of the disclosure, the mining haul truck may include a radiator positioned at the first end portion of the vehicle chassis adjacent to the first end of the vehicle chassis.

In various aspects of the disclosure, the mining haul truck may include a fuel cell module positioned within the side saddle and coupled to the vehicle chassis.

In various aspects of the disclosure, the mining haul truck may include a first wheel coupled to the first longitudinal member at a forward position and a second wheel coupled to the first longitudinal member at a rearward position. The first wheel and the second wheel may define a side saddle therebetween. A fuel cell module may be positioned in the side saddle and coupled to the vehicle chassis.

In various aspects of the disclosure, the mining haul truck may include a fluid tank positioned within the vehicle chassis space in a vertical arrangement with the first battery module so that the fluid tank is above the first battery module. The fluid tank may contain one of methanol and ammonia. The fluid tank may be a hydrogen tank.

In various aspects of the disclosure, the mining haul truck may include a deck supported by the first end portion of the vehicle chassis and a balance-of-plant module supported by the deck. The mining haul truck may include an air cleaner supported by the balance-of-plant module.

In various aspects of the disclosure, the mining haul truck may include a radiator positioned at the first end portion of the vehicle chassis adjacent the first end of the vehicle chassis.

In various aspects of the disclosure, the mining haul truck may include a battery module mounted in the vehicle chassis space.

In various aspects of the disclosure, the mining haul truck may include a fuel cell module positioned in one of the first side saddle and the second side saddle and coupled to the vehicle chassis. The mining haul truck may include a hydraulic tank positioned in the other of the first side saddle and the second side saddle and coupled to the vehicle chassis.

In various aspects of the disclosure, the mining haul truck may include a heat exchanger positioned in the rear chassis space and coupled to the vehicle chassis.

In various aspects of the disclosure, the mining haul truck may further include a first wheel coupled to the first longitudinal member at a forward position and a second wheel coupled to the first longitudinal member at a rearward position, and the method may include mounting a fluid tank to the first longitudinal member within the first side saddle. The fluid tank may contain one of methanol and ammonia. The fluid tank may be a hydrogen tank.

In various aspects of the disclosure, the method may include mounting a second battery module to the power module support frame within the vehicle chassis space. The method may include mounting a second fuel cell module in a vertical arrangement with the second battery module so that the second fuel cell module is supported by the power module support frame above the second battery module. The method may include positioning a balance-of-plant module within the vehicle chassis space so that the balance-of-plant module is supported by the power module support frame. The step of mounting the first battery module may include mounting the first battery module to a top surface of the power module support frame, and the step of mounting the second battery module may include mounting the second battery module to a bottom surface of the power module support frame.

In various aspects of the disclosure, the mining haul truck may include a balance-of-plant module integrated with the first fuel cell module.

In various aspects of the disclosure, the method may include positioning a balance-of-plant module in a position spaced-apart from the first fuel cell module. The step of positioning the balance-of-plant module may include positioning the balance-of-plant module in a forward position relative to the first fuel cell module.

In various aspects of the disclosure, the mining haul truck may include a deck supported by a first end portion of the vehicle chassis, and the method may include mounting a radiator to the mining truck adjacent to a forwardmost position of the deck. The first end portion of the vehicle chassis may be associated with the first end of the vehicle chassis. The method may include mounting a plurality of fans to the mining truck adjacent to the radiator. The method may include mounting an air cleaner to the mining haul truck between the radiator and a balance-of-plant module.

In various aspects of the disclosure, the method may include positioning a balance-of-plant module associated with the first fuel cell module in a vertical arrangement with the power module support frame so that the balance-of-plant module is supported by the power module support frame.

In various aspects of the disclosure, the mining truck may include a first wheel coupled to the first longitudinal member at a forward position and a second wheel coupled to the first longitudinal member at a rearward position, and the method may include mounting a fluid tank to the vehicle chassis within a side saddle defined between the first wheel and the second wheel. The fluid tank may contain one of methanol and ammonia. The fluid tank may be a hydrogen tank.

In various aspects of the disclosure, the method may include mounting a battery module to the mining truck at a first end portion of the chassis adjacent to the first end of the vehicle chassis.

In various aspects of the disclosure, the method may include positioning a plurality of fans so that the plurality of fans is supported by the power module support frame adjacent to the radiator.

In various aspects of the disclosure, the method may include mounting a fluid tank to the vehicle chassis within a side saddle defined between the first wheel and the second wheel. The fluid tank may contain one of methanol and ammonia. The fluid tank may be a hydrogen tank.

In various aspects of the disclosure, the method may include mounting an air cleaner to the first end portion.

In various aspects of the disclosure, the method may include mounting a fuel cell module to a power module support frame coupled to the vehicle chassis within the vehicle chassis space. The method may include mounting a balance-of-plant module to the power module support frame within the vehicle chassis space. The method may include positioning a radiator in a vertical arrangement with the fuel cell module and the balance-of-plant module so that the radiator is supported by the power module support frame above the fuel cell module and the balance-of-plant module. Positioning the radiator may include angling the radiator relative to the fuel cell module to define a triangular space between the fuel cell module and the radiator. An angle defined between the radiator and the fuel cell module may be 30°-45°. The method may include positioning a plurality of fans so that the plurality of fans is supported by the power module support frame adjacent to the radiator. The method may include mounting a second battery module to the power module support frame within the vehicle chassis space. The method may include positioning a hydrogen tank in a vertical arrangement with the second battery module so that the hydrogen tank is supported by the power module support frame above the second battery module.

The method may include mounting a battery module to the power module support frame in a vertical arrangement with the fuel cell module so that the fuel cell module is positioned above the battery module. The method may include mounting a fluid tank to the power module support frame in a vertical arrangement with the fuel cell module so that the fuel cell module is positioned above the battery module. The method may include positioning an outlet of the air inlet assembly adjacent to the fuel cell module.

In various aspects of the disclosure, the method may include mounting a fluid tank to the power module support frame within the vehicle chassis space. The fluid tank may contain one of methanol and ammonia. The fluid tank may be a hydrogen tank.

In various aspects of the disclosure, the method may include mounting a balance-of-plant module to the deck. The method may include positioning an air cleaner so that the air cleaner is supported by the balance-of-plant module.

In various aspects of the disclosure, the method may include mounting a radiator to the front end portion of the vehicle chassis adjacent the first end of the vehicle chassis.

In various aspects of the disclosure, the method may include mounting a fuel cell module to the vehicle chassis within the side saddle.

In various aspects of the disclosure, the mining haul truck may include a first wheel coupled to the first longitudinal member at a forward position and a second wheel coupled to the first longitudinal member at a rearward position, and the method may include mounting a fuel cell module to the vehicle chassis within a side saddle defined between the first wheel and the second wheel.

In various aspects of the disclosure, the method may include positioning a fluid tank in vertical arrangement with the first battery module so that the fluid tank is supported by the power module support frame above the first battery module. The fluid tank may contain one of methanol and ammonia. The fluid tank may be a hydrogen tank.

In various aspects of the disclosure, the method may include mounting a balance-of-plant module on the deck. The method may include positioning an air cleaner so that the air cleaner is supported by the balance-of-plant module.

In various aspects of the disclosure, the method may include mounting a radiator at a first end portion of the vehicle chassis adjacent the first end of the vehicle chassis.

In various aspects of the disclosure, the method may include positioning a first battery module within the vehicle chassis space so that the first battery module is supported by the power module support frame. Positioning the first battery module may include positioning the first battery module between the power module support frame and the fluid tank. The method may include mounting a second battery module adjacent to the first end of the vehicle chassis.

In various aspects of the disclosure, the fluid tank may contain one of methanol and ammonia.

In various aspects of the disclosure, the fluid tank may be a hydrogen tank.

In various aspects of the disclosure, the method may include positioning a balance-of-plant module within the vehicle chassis space so that the balance-of-plant module is supported by the power module support frame. Positioning the balance-of-plant module may include positioning the balance-of-plant module between the power module support frame and the fluid tank. Positioning the balance-of-plant module may include positioning the balance-of-plant module so that the balance-of-plant module is further supported by the fluid tank. Positioning the balance-of-plant module may include positioning the balance-of-plant module so that the balance-of-plant module is rearward relative to the fluid tank. The method may include positioning an air cleaner so that the air cleaner is supported by the balance-of-plant module.

In various aspects of the disclosure, the method may include mounting a fuel cell module to the vehicle chassis within at least one of the first side saddle and the second side saddle.

In various aspects of the disclosure, the method may include mounting a battery module to the vehicle chassis within at least one of the first side saddle and the second side saddle.

In various aspects of the disclosure, the method may include mounting a fuel cell module to the vehicle chassis within one of the first side saddle and the second side saddle and mounting a battery module to the vehicle chassis in the other of the first side saddle and the second side saddle.

In various aspects of the disclosure, the method may include mounting a second fluid tank within one of the first side saddle, the second side saddle, and the vehicle chassis space in a position adjacent to the first fluid tank. The method may include mounting the second fluid tank within the vehicle chassis space in a position adjacent to the first fluid tank so that the first fluid tank and the second fluid tank are in a vertical arrangement. The method may include mounting a third fluid tank within another of the first side saddle, the second side saddle, and the vehicle chassis space adjacent to the first fluid tank. The first fluid tank may contain a first fluid and the second fluid tank may contain a second fluid different than the first fluid.

In various aspects of the disclosure, the method may include mounting a radiator adjacent the first end of the vehicle chassis. Mounting the radiator may include hingedly mounting the radiator. The method may include positioning a plurality of fans between the radiator and the first fluid tank.

In various aspects of the disclosure, the method may include mounting a fuel cell module within the vehicle chassis space adjacent to the first fluid tank so that the fuel cell stack is supported by the power module support frame. Mounting the fuel cell module may include positioning the fuel cell module so that the fuel cell module is also supported by the fluid tank. Mounting the fuel cell module may include positioning the fuel cell module so that the fuel cell module is also supported by the fluid tank. Mounting the fuel cell module includes positioning the fuel cell module between the power module support frame and the fluid tank.

In various aspects of the disclosure, the method may include mounting an air cleaner on the deck adjacent to the first end of the chassis.

In various aspects of the disclosure, the method may include mounting a resistor grid on the deck.

In various aspects of the disclosure, the method may include mounting an inverter cabinet on the deck.

In various aspects of the disclosure, the fluid tank may be cylindrical.

In various aspects of the disclosure, the method may include mounting a DC/DC system within the vehicle chassis space in a vertical arrangement with the fluid tank so that the DC/DC system is positioned above the fluid tank and supported by the power module support frame.

In various aspects of the disclosure, the method may include mounting a heat exchanger within a rear chassis space defined between the second wheel and the fourth wheel.

In various aspects of the disclosure, the method may include mounting a battery module to a power module support frame in the vehicle chassis space.

In various aspects of the disclosure, the method may include mounting a fuel cell module to the vehicle chassis in one of the first side saddle and the second side saddle. The method may include mounting a hydraulic tank to the vehicle chassis in the other of the first side saddle and the second side saddle.

In various aspects of the disclosure, the method may include mounting a heat exchanger to the vehicle chassis in the rear chassis space.

In various aspects of the disclosure, the mining haul truck may include a fuel cell module mounted to a power module support frame within the vehicle chassis space and coupled to the vehicle chassis. A battery module may be mounted to the power module support frame in a vertical arrangement with the fuel cell stack so that the fuel cell stack is positioned above the battery module. A fluid tank may be mounted to the power module support frame in a vertical arrangement with the fuel cell module so that the fuel cell module is positioned above the battery module. The air inlet assembly may include an outlet positioned adjacent to the fuel cell module.

In various aspects of the disclosure, the mining haul truck may include an air pump positioned within a body of the air inlet assembly.

In various aspects of the disclosure, the mining haul truck may include a balance-of-plant module positioned within a body of the air inlet assembly.

In various aspects of the disclosure, the mining haul truck may include a second filter positioned within a body of the air inlet assembly.

In various aspects of the disclosure, the mining haul truck may include an exhaust positioned between a portion of the air inlet assembly and a bottom surface of the deck.

In various aspects of the disclosure, the mining haul truck may include a first wheel mounted to a forward position of the first longitudinal member of the vehicle chassis; a second wheel mounted to a rearward position of the first longitudinal member of the vehicle chassis; a side saddle defined between the first wheel and the second wheel; and a battery module mounted to the vehicle chassis within the side saddle.

In various aspects of the disclosure, the mining truck may include a first wheel mounted to a forward position of the first longitudinal member of the vehicle chassis; a second wheel mounted to a rearward position of the first longitudinal member of the vehicle chassis; a side saddle defined between the first wheel and the second wheel; and a fluid tank mounted to the vehicle chassis within the side saddle. The fluid tank may contain one of methanol and ammonia. The fluid tank may be a hydrogen tank.

In various aspects of the disclosure, the mining haul truck may include a radiator mounted at a first end portion of the vehicle chassis adjacent the first end of the vehicle chassis. The radiator may be hingedly mounted.

In various aspects of the disclosure, the mining haul truck may include a DC/DC system mounted to a power module support frame within the vehicle chassis space and coupled to the vehicle chassis. The mining haul truck may include a first wheel mounted to a forward position of the first longitudinal member of the vehicle chassis; a second wheel mounted to a rearward position of the first longitudinal member of the vehicle chassis; a side saddle defined between the first wheel and the second wheel; and a fuel cell module mounted to the vehicle chassis within the side saddle.

In various aspects of the disclosure, the deck may define an access panel.

In various aspects of the disclosure, the method may include positioning an air pump within a body of the air inlet assembly.

In various aspects of the disclosure, the method may include positioning a balance-of-plant module within a body of the air inlet assembly.

In various aspects of the disclosure, the method may include positioning a second filter within a body of the air inlet assembly.

In various aspects of the disclosure, the method may include positioning an exhaust between a portion of the air inlet assembly and a bottom surface of the deck.

In various aspects of the disclosure, the mining haul truck may include a first wheel mounted to a forward position of the first longitudinal member of the vehicle chassis, a second wheel mounted to a rearward position of the first longitudinal member of the vehicle chassis, and a side saddle defined between the first wheel and the second wheel. The method may include mounting a battery module to the vehicle chassis within the side saddle.

In various aspects of the disclosure, the mining truck may include a first wheel mounted to a forward position of the first longitudinal member of the vehicle chassis, a second wheel mounted to a rearward position of the first longitudinal member of the vehicle chassis, and a side saddle defined between the first wheel and the second wheel. The method may include mounting a fluid tank to the vehicle chassis within the side saddle. The fluid tank may contain one of methanol and ammonia. The fluid tank may be a hydrogen tank.

In various aspects of the disclosure, the method may include mounting a radiator at the first end portion of the vehicle chassis adjacent the first end of the vehicle chassis. Mounting the radiator may include hingedly mounting the radiator.

In various aspects of the disclosure, the method may include mounting a DC/DC system to a power module support frame coupled to the vehicle chassis within the vehicle chassis space. The mining haul truck may include a first wheel mounted to a forward position of the first longitudinal member of the vehicle chassis, a second wheel mounted to a rearward position of the first longitudinal member of the vehicle chassis, and a side saddle defined between the first wheel and the second wheel. The method may include mounting a fuel cell module to the vehicle chassis within the side saddle.

In various aspects of the disclosure, the fuel cell module arrangement may include a second battery module coupled to a bottom surface of the power module support frame.

In various aspects of the disclosure, the fuel cell module arrangement may include a second fuel cell module positioned above the first battery module and having a second connection end facing a second direction. The first direction and the second direction may be opposite of each other. The fuel cell module arrangement may include a second balance-of-plant module coupled to a top surface of the power module support frame. The second balance-of-plant module may be operably connected to the second connection end of the second fuel cell module. The first balance-of-plant module may be coupled to the top surface of the power module support frame corresponding with a first longitudinal half of the power module support frame. The second balance-of-plant module may be coupled to the top surface of the power module support frame corresponding with a second longitudinal half of the power module support frame.

The first fuel cell module may be a plurality of fuel cell modules. The plurality of fuel cell modules may include a stacked pair of fuel cell modules. The plurality of fuel cell modules may include two stacked pairs of fuel cell modules. The first balance-of-plant module may be a plurality of balance-of-plant modules. The plurality of balance-of-plant modules may include a stacked pair of balance-of-plant modules. The plurality of balance-of-plant modules may include two stacked pairs of fuel cell modules. The first connection end of each fuel cell module of the plurality of fuel cell modules may face a first direction. Each balance-of-plant module of the plurality of balance-of-plant modules may be arranged on a first longitudinal half of the power module support frame corresponding with the first direction. The fuel cell module arrangement may include a second plurality of fuel cell modules positioned above the first battery pack module. Each fuel cell of the second plurality of fuel cell modules may have a second connection end facing a second direction. A second plurality of balance-of-plant modules may be coupled on a second longitudinal half of the power module support frame corresponding with the second direction.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The detailed description of the drawings particularly refers to the accompanying figures in which:

FIG. 1 is a schematic top-down illustration of an exemplary architecture arrangement of components of a mining truck;

FIG. 2 is a perspective illustration of an exemplary chassis and components mounted thereon;

FIG. 3 is a perspective illustration of an exemplary fuel cell arrangement including fuel cell module(s) with corresponding integrated balance-of-plant modules;

FIG. 4A is a first side illustration of an exemplary fuel cell arrangement including fuel cell module(s) with corresponding remote balance-of-plant modules;

FIG. 4B is a second side illustration of the fuel cell arrangement of FIG. 4A;

FIG. 4C is a first end illustration of the fuel cell arrangement of FIG. 4A;

FIG. 4D is a perspective illustration of the fuel cell arrangement of FIG. 4A;

FIG. 5 is a perspective illustration of an exemplary chassis wherein the fuel cell arrangement of FIG. 4A is mounted thereon;

FIG. 6 is a schematic illustration of an exemplary architecture of a first end of a mining truck;

FIG. 7A is a schematic top-down illustration of another exemplary architecture arrangement of components of a mining truck;

FIG. 7B is a schematic first side illustration of the architecture arrangement of FIG. 7A;

FIG. 7C is a schematic second side illustration of the architecture arrangement of FIG. 7A;

FIG. 8 is a schematic side illustration of an exemplary architecture arrangement of components of a mining truck;

FIG. 9 is a schematic side illustration of another exemplary architecture arrangement of components of a mining truck;

FIG. 10 is a schematic side illustration of an exemplary architecture arrangement of components of a mining truck;

FIG. 11 is a schematic side illustration of another exemplary architecture arrangement of components of a mining truck;

FIG. 12 is a schematic side illustration of an exemplary architecture arrangement of components of a mining truck;

FIG. 13 is a schematic side illustration of another exemplary architecture arrangement of components of a mining truck;

FIG. 14 is a schematic side illustration of an exemplary architecture arrangement of components of a mining truck;

FIG. 15 is a schematic side illustration of another exemplary architecture arrangement of components of a mining truck;

FIG. 16 is a schematic side illustration of an exemplary architecture arrangement of components of a mining truck;

FIG. 17A is a schematic perspective illustration of another exemplary architecture arrangement of components of a mining truck;

FIG. 17B is a schematic side illustration of the exemplary architecture arrangement of FIG. 17A;

FIG. 18 is a schematic side illustration of an exemplary architecture arrangement of components of a mining truck;

FIG. 19A is a schematic side illustration of another exemplary architecture arrangement of components of a mining truck with a first position of an air filter;

FIG. 19B is a schematic side illustration of the exemplary architecture arrangement of FIG. 19A, with an alternate position of the air filter;

FIG. 20A is a schematic side illustration of an exemplary architecture arrangement of components of a mining truck;

FIG. 20B is a schematic side illustration of the exemplary architecture arrangement of FIG. 20A, further including a heat exchanger positioned within a rear region of a chassis of the mining truck;

FIG. 20C is a schematic side illustration of the exemplary architecture arrangement of FIG. 20B, with an alternate position of one or more balance-of-plant modules;

FIG. 21 is a schematic illustration of an arrangement of a deck of a mining truck including an access panel; and

FIG. 22 is a schematic illustration of a hinged radiator mounted to an end of a mining truck.

Although the drawings represent embodiments of various features and components according to the present disclosure, the exemplification set out herein illustrates an embodiment, and such an exemplification is not to be construed as limiting the scope of the disclosure in any manner.

### DETAILED DESCRIPTION OF THE DRAWINGS

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., is used in reference to various components of features. Such use is not intended to denote an ordering of the components or features. Rather, numeric terminology is used to assist the reader in identifying the components or features being referenced and should not be narrowly interpreted as providing a specific order of components or features.

While the disclosure herein is provided in terms of a “mining truck”, it is understood that the features described herein may apply to other vehicles, including heavy equipment such as cranes, bulldozers, excavators, etc., locomotives, and other appropriate vehicles.

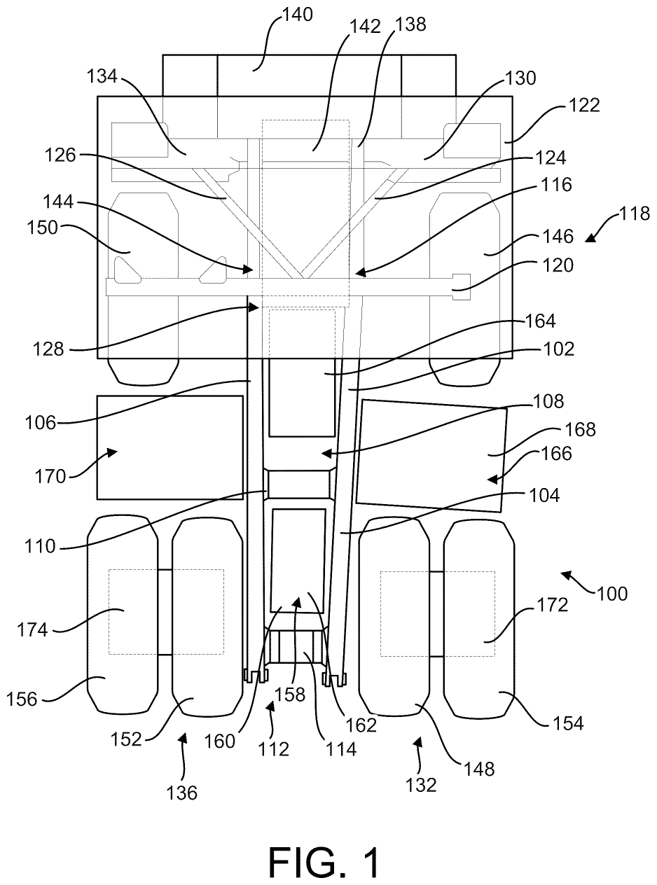

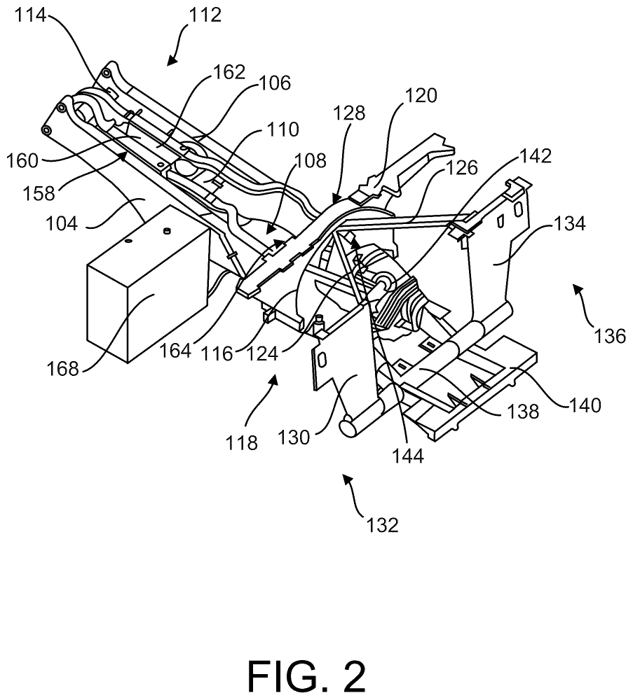

A schematic architecture of an exemplary mining truck 100 is illustrated in FIG. 1. As shown, mining truck 100 is generally built on and/or around chassis 102. Referring additionally to FIG. 2, chassis 102 includes a first frame member 104 and a second frame member 106 extending longitudinally from a first end portion of the chassis including a first end of the chassis to a second end portion of the chassis including a second end of the chassis to at least partially define a length of mining truck 100. First frame member 104 and second frame member 106 may be spaced apart to form a space 108 therebetween, with a central crossbeam 110 extending from first frame member 104 to second frame member 106 across space 108, generally defining a rear chassis region 112. A rear crossbeam 114 may extend from first frame member 104 to second frame member 106 across space 108 at the rear of chassis 102, and a horse collar 116 may connect first frame member 104 and second frame member 106 within a forward region 118 of chassis 102.

A third frame member 120 may extend across the top of horse collar 116 and beyond the diameter of horse collar 116 to form a support for a deck 122 (FIG. 1) as described further herein. A first supplemental frame member 124 and a second supplemental frame member 126 may each extend diagonally from a central portion 128 of third frame member 120 above horse collar 116 in opposite directions so that first supplemental frame member 124 may connect to a first support plate 130 and second supplemental frame member 126 connects to a second support plate 134. First support plate 130 may also connect to first frame member 104 on a first side 132 of chassis 102, and second support plate 134 may also connect to second frame member 106 on a second side 136 of chassis 102.

A forward crossbeam 138 may extend from first frame member 104 to second frame member 106 in general alignment with first support plate 130 and second support plate 134. A support extension 140 may extend forward of forward crossbeam 138. An engine 142 may be positioned within an opening 144 defined by horse collar 116. A traction alternator and/or gearbox may be mounted rearward of engine 142 within area 164.

Referring again to FIG. 1, wheels 146, 148, 150, and 152 may be mounted to chassis 102 via respective axles (not shown). For example, as shown, first wheel 146 may be mounted at a forward position in forward region 118 on first side 132 of chassis 102. Second wheel 148 may be mounted at a rearward position in rear region 112 on first side 132 of chassis 102. Third wheel 150 may be mounted at a forward position in forward region 118 on second side 136 of chassis 102. Fourth wheel 152 may be mounted at a rearward position in rear region 112 on second side 136 of chassis 102. In some embodiments, mining truck 100 may include a fifth wheel 154 mounted adjacent to second wheel 148 at a rearward position in rear region 112 on first side 132 of chassis 102. Some embodiments may additionally include a sixth wheel 156 mounted adjacent to fourth wheel 152 at a rearward position in rear region 112 on second side 136 of chassis 102. First wheel 146 and third wheel 150 may be mounted at a position generally corresponding to third frame member 102.

A rear region space 158 defined between first frame member 104 and second frame member 106 within rear chassis region 112, and at least partially defined between second wheel 148 and fourth wheel 152, may be sized and shaped to receive a vehicle subsystem 160. For example, as shown in FIG. 2, vehicle subsystem 160 may include an aftertreatment system 162. In other embodiments, vehicle subsystem 160 may include one or more battery module(s), a fuel tank, an exhaust muffler, an exhaust silencer, a powertrain support subsystem, or any other vehicle subsystems necessary or otherwise desired for operation of mining truck 100. As described herein, an exhaust muffler and an exhaust silencer may be similar or the same components intended to quiet an exhaust by some volume. In other embodiments, rear region space 158 may be free of any vehicle subsystems or components.

First wheel 146 and second wheel 148 define a space, or first side saddle 166 therebetween. In some embodiments, as illustrated in FIGS. 1-2, a fuel tank 168 may be mounted to chassis 102 within first side saddle 166. Fuel tank 168 may contain, for example, diesel fuel or an alternative fuel, e.g., ammonia, methanol, ethanol, or other fuels suitable for operation of mining truck 100. In some embodiments, alternative components may be mounted within first side saddle 166 as discussed further herein. Likewise, third wheel 150 and fourth wheel 152 may define a space, or second side saddle 170. A first wheel motor 172 may be associated with second wheel 148 and, in embodiments including a fifth wheel, fifth wheel 154. A second wheel motor 174 may be associated with fourth wheel 152 and, in embodiments including a sixth wheel, sixth wheel 156. In some embodiments including a fifth and/or sixth wheel, each of second wheel 148, fourth wheel 152, fifth wheel 154, and sixth wheel 156 may have a separate wheel motor. In other embodiments, all of wheels 146, 148, 150, 152, 154, and 156 or wheels 146, 148, 150, 152, or any combination thereof, may be associated with a wheel motor, whether such wheel motor is designated to a single wheel or such wheel motor is shared between two or more wheels.

Still referring to FIG. 1, deck 122 may be supported by chassis 102, and, for example, by third frame member 120, first support plate 130, and second support plate 134. In other words, deck 122 may be supported by the first end portion of chassis 102, wherein the first end portion of chassis 102 includes a first end of the chassis 102. Deck 122 may be configured to support a cab to facilitate operation of mining truck 100 and various vehicle subsystems, including hybrid powertrain subsystems and components as discussed further herein.

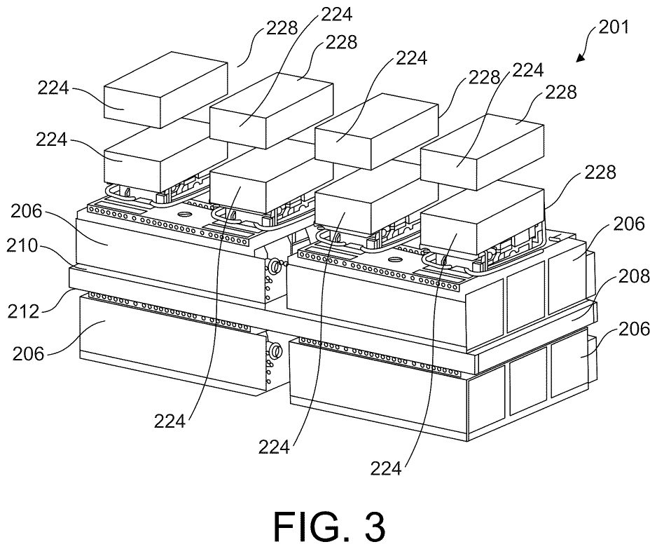

Now referring to FIG. 3, an exemplary fuel cell arrangement 201 is illustrated. Fuel cell arrangement 201 includes a plurality of fuel cell modules 224 arranged in pairs, each fuel cell module 224 including an integrated balance-of-plant module 228. Balance-of-plant module 228 may include any, including all or a portion of components required for operation of the corresponding fuel cell module 224. For example, balance-of-plant module 228 may include components related to air management, fuel management, fuel cell stack management, and integration or connection of the components listed above and/or other components to corresponding fuel cell module(s) 224. Such components may include, but are not limited to, pumps, sensors, compressors, humidifiers, heat exchangers, valves, sealing material, conduits, gaskets, and/or other components to facilitate operation of corresponding fuel cell module(s) 224.

Fuel cell module(s) as referred to herein may include any type of fuel cell packaging including one or more fuel cell stack(s) for operation of a vehicle. For example, fuel cell module(s) may include fuel cell packaging including polymer electrolyte membrane fuel cells (i.e., proton exchange membrane fuel cells), direct methanol fuel cells, alkaline fuel cells (including alkaline membrane fuel cells), phosphoric acid fuel cells, molten carbonate fuel cells, solid oxide fuel cells, and reversible fuel cells.

As shown in FIG. 3, each fuel cell module 224 may have its own balance-of-plant module 228 which is integrated directly with its corresponding fuel cell module 224. Fuel cell module(s) 224 may be arranged in stacked pairs and positioned on one or more battery module(s) 206 and/or a power module support frame 208 to facilitate packaging of fuel cell arrangement 201 for fitting of fuel cell arrangement 201 within architecture of mining truck 100. For example, fuel cell module(s) 224 may be positioned on a first layer of battery module(s) 206 and first layer of battery module(s) 206 may be mounted on a top surface 210 of power module support frame 208. In some embodiments, as illustrated, a second layer of battery module(s) 206 may be mounted underneath power module support frame 208, e.g., to a bottom surface 212 of power module support frame 208. In some embodiments, fuel cell arrangement 201 may only have one layer of battery module(s) 206 mounted either above or below power support module 208. In other embodiments, fuel cell arrangement 201 may not have any battery module 206 layers. In yet other embodiments, fuel cell arrangement 201 may include a greater layer of battery module(s) 206 mounted above and/or below power module support frame 208. Battery module(s) 206 as described here and further herein may include, for example, a battery pack or another gathering of battery module(s) as known in the art.

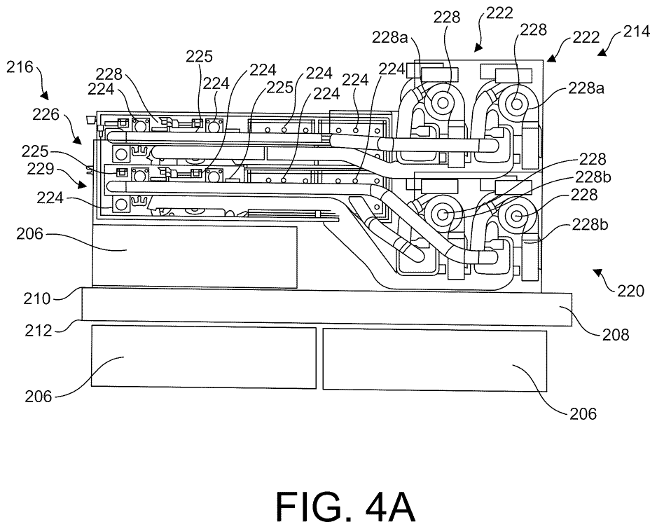

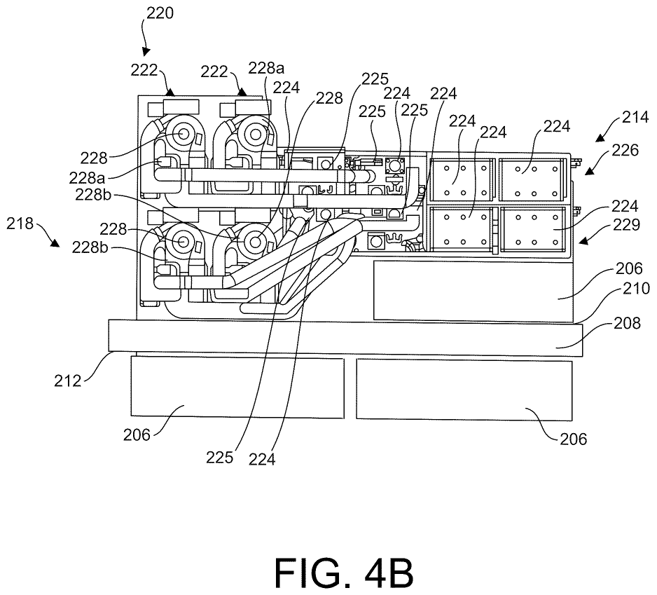

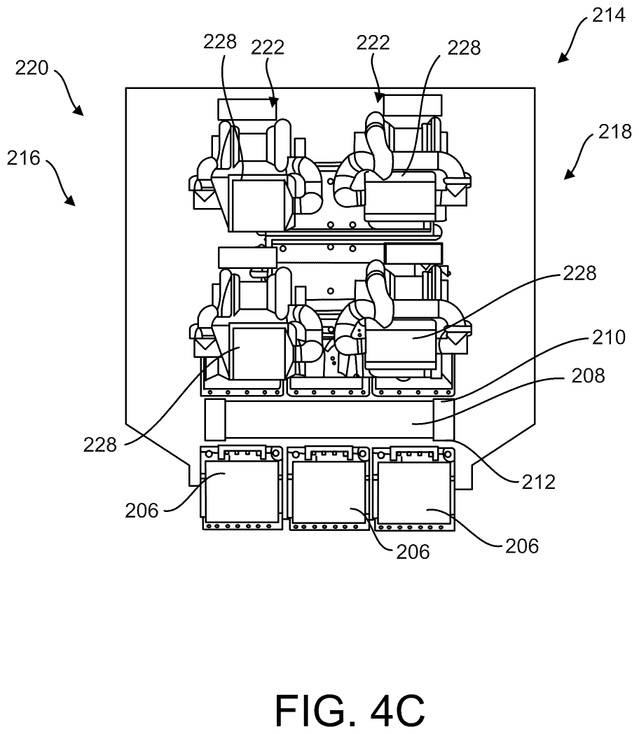

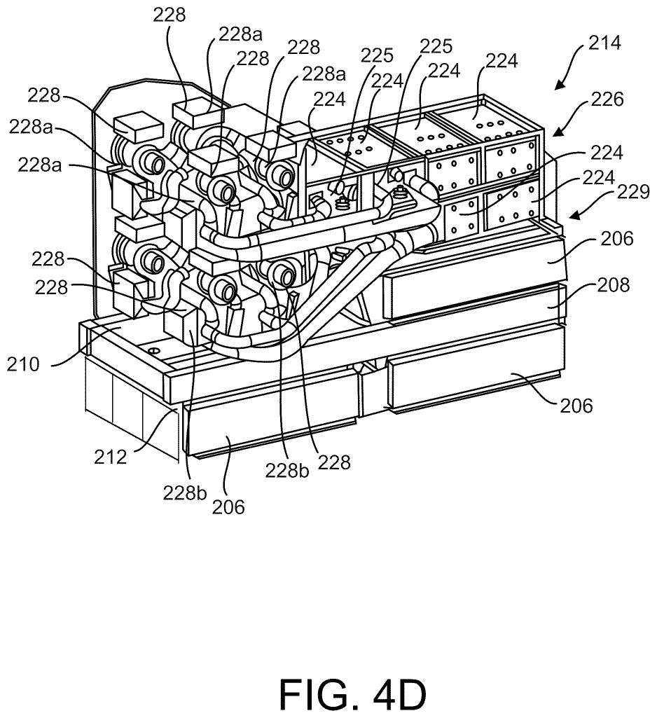

Now referring to FIGS. 4A-4D, a second exemplary fuel cell arrangement 214 is illustrated. Fuel cell arrangement 214 includes a plurality of fuel cell modules 224 and one or more balance-of-plant module 228 as described above in relation to fuel cell arrangement 201. However, in fuel cell arrangement 214, balance-of-plant module 228 may be positioned remote from its corresponding fuel cell module(s) 224. In other words, balance-of-plant module 228 may not be integrated with a corresponding fuel cell but is instead arranged separately from its corresponding fuel cell module(s) 224. In some embodiments, each fuel cell module 224 may have its own designated balance-of-plant module 228. In other embodiments, one balance-of-plant module 228 may service multiple fuel cell modules 224.

FIG. 4A shows a first side 216 of fuel cell arrangement 214, FIG. 4B shows a second side 218 of fuel cell arrangement 214, FIG. 4C illustrates a front end 220 of fuel cell arrangement 214, and FIG. 4D illustrates a perspective view of fuel cell arrangement 214. As shown referring to all of FIG. 4A-4D, fuel cell arrangement 214 may include eight balance-of-plant modules 228, arranged in two side-by-side stacked pairs 222 on each of first side 216 and second side 218. In other words, fuel cell arrangement 214 may include four balance-of-plant modules 228 on first side 216 and four balance-of-plant modules 228 on second side 218. As mentioned above, balance-of-plant modules 228 may be arranged in two stacked side-by-side pairs 222. In other words, each pair 222 includes a top balance-of-plant module 228a and a bottom balance-of-plant module 228b. Each bottom balance-of-plant module 228b may be positioned and/or mounted on top surface 210 of power module support frame 208. Balance-of-plant modules 228 may be arranged closest to front end 220 of fuel cell arrangement 214 relative to fuel cell modules 224 as discussed further below.

Fuel cell arrangement 214 may include eight fuel cell modules 224 arranged in two rows of four. In other words, fuel cell arrangement 214 may include a top row 226 of four fuel cell modules 224 and a bottom row 229 of four fuel cell modules 224. Fuel cell modules 224 may be positioned behind balance-of-plant modules 228 relative to front end 220 of fuel cell arrangement 214. Each fuel cell module 224 may have a connection end 225 configured to facilitate coupling of the fuel cell module 224 with its respective balance-of-plant module 228. For example, as illustrated especially in FIGS. 4A, 4B, and 4D, four fuel cell modules 224 may have a connection end 225 facing first side 216 of fuel cell arrangement 214 to facilitate coupling with the four balance-of-plant modules 228 on first side 216 of fuel cell arrangement 214. Similarly, four fuel cell modules 224 may have a connection end 225 facing second side 218 of fuel cell arrangement 214 to facilitate coupling with the four balance-of-plant modules 228 on second side 218 of fuel cell arrangement 214.

Fuel cell modules 224 may be positioned a first layer of one or more battery module(s) 206 which are positioned and/or mounted on top surface 210 of power module support frame 208. In some embodiments, as illustrated, a second layer of one or more battery module(s) 206 may be mounted underneath power module support frame 208, e.g., to bottom surface 212 of power module support frame 208. In some embodiments, fuel cell arrangement 214 may only have one layer of battery module(s) 206 mounted either above or below power support module 208. In other embodiments, fuel cell arrangement 201 may not have any battery module 206 layers. In yet other embodiments, fuel cell arrangement 214 may include a greater layer of battery module(s) 206 mounted above and/or below power module support frame 208. The positioning of fuel cell modules 224 on at least one layer of battery module(s) 206 may position fuel cell modules 224 in a way that facilitates connection of each fuel cell module 224 to its corresponding balance-of-plant module 228.

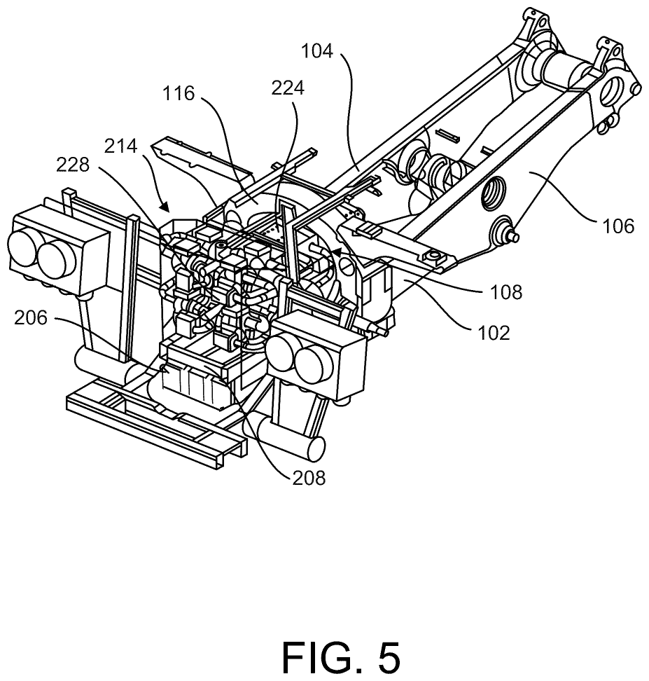

FIG. 5 illustrates the positioning of fuel cell arrangement 214 in chassis 102. As illustrated, fuel cell modules 224 arranged on the first layer of battery module(s) 206 (FIGS. 4A-4D) may be appropriately sized and shaped to fit within horse collar 116 and extend into space 108 between first frame member 104 and second frame member 106 of chassis 102 behind horse collar 116. Balance-of-plant modules 228 may be of a height too great to fit within horse collar 116 as illustrated in FIG. 5. In such an arrangement, balance-of-plant modules 228 may be positioned forward of horse collar 116 while fuel cell modules 224 extend through horse collar 116 and into space 108. As illustrated in FIG. 6, a radiator 202 may be positioned on a front end 230 of mining truck 100, flanked on either side or both sides by one or more chillers 232. A DC/DC system 196, along with other electronics and subsystems, may be positioned on deck 122 of mining truck 100, as discussed further herein.

While fuel cell arrangement 214 is discussed as having a specific number of fuel cell modules 224 and balance-of-plant modules 228, it is within the scope of the disclosure to have a greater or fewer number of fuel cell modules 224 and/or balance-of-plant modules 228. Further, it is within the scope of the disclosure for the balance-of-plant modules 228 and/or fuel cell modules 224 alternately arranged relative to each other and/or to other components discussed further herein. The specific arrangement and number of the fuel cell modules 224 and balance-of-plant modules 228 as discussed relative to fuel cell arrangement 214 as described herein are meant to be exemplary in nature only and may vary according to the needs and desire of a user. For example, while the arrangement of FIG. 5 illustrates the positioning of fuel cell arrangement 214 within horse collar 116 of chassis 102, embodiments described further herein may position fuel cell modules 224 and/or balance-of-plant modules 228 at different positions relative to the corresponding mining truck 100.

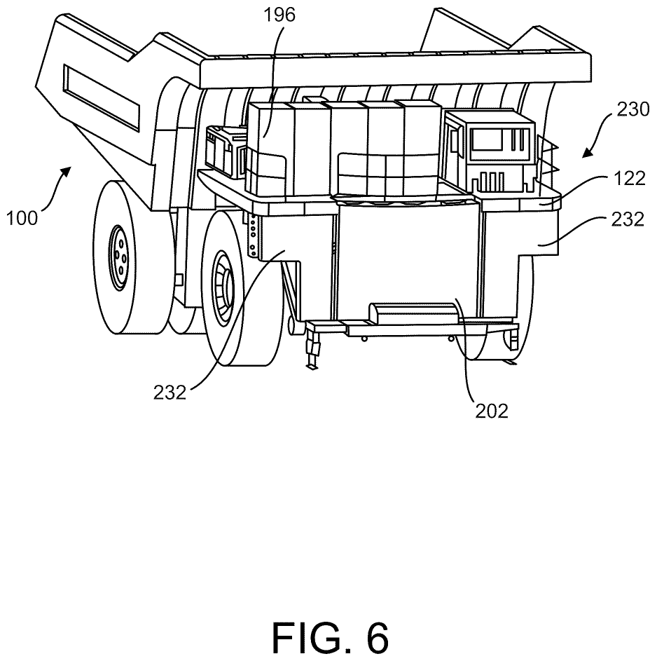

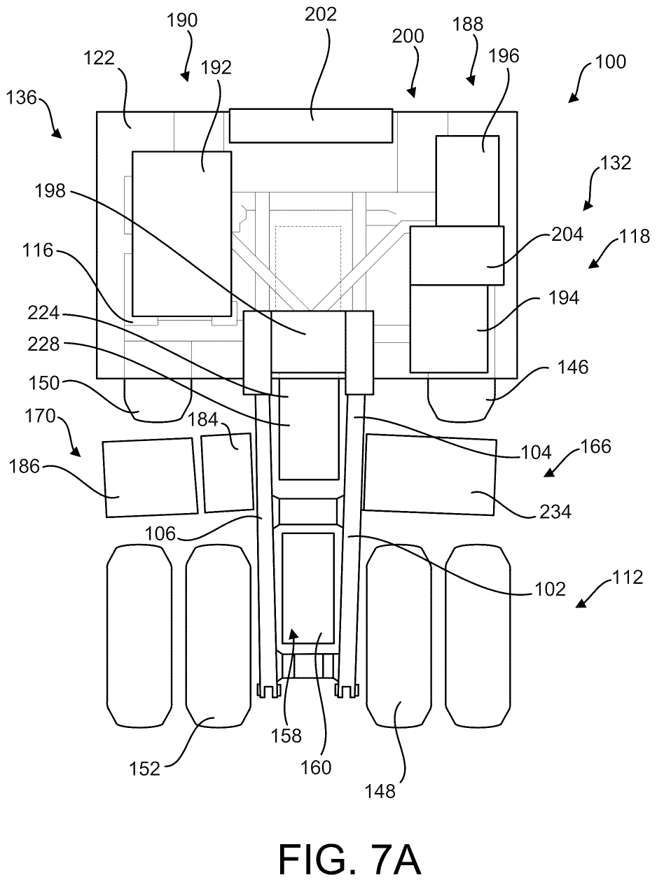

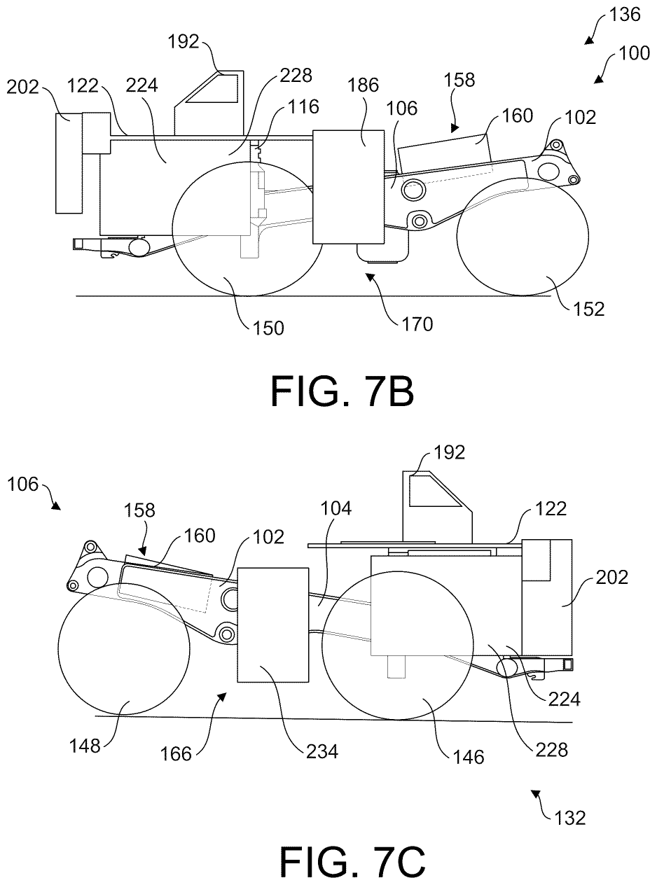

Now referring to FIGS. 7A-7C, an exemplary architecture of a mining truck 100 is schematically illustrated. Mining truck 100 as illustrated in FIGS. 7A-7C includes the same components and details as described above, except as described further herein, with like components associated with like reference numbers.

As described above, mining truck 100 may include chassis 102 having first frame member 104 and second frame member 106. First wheel 146 may be mounted at a forward position in forward region 118 on first side 132 of chassis 102, i.e., adjacent to first frame member 104. Second wheel 148 may be mounted at a rearward position in rear region 112 on first side 132 of chassis 102, i.e., adjacent to first frame member 104, and spaced apart from first wheel 146 to define first side saddle 166 therebetween. A primary hydrogen tank 234 may be mounted to first side 132 of chassis 102 within first side saddle.

Mounting of primary hydrogen tank 234 within first side saddle 166 may facilitate an even balance of mining truck 100 when one or more tanks are also mounted to chassis 102 within second side saddle 170 as discussed further herein. It is also within the scope of this disclosure that primary hydrogen tank 234 and/or additional hydrogen tanks may be alternately positioned, whether in a single, unified space or in a plurality of places throughout architecture of mining truck 100 (i.e., on deck 122, within rear region space 158, or another placement).

Still referring to FIGS. 7A-7C, third wheel 150 may be mounted at a forward position in forward region 118 on second side 136 of chassis 102, i.e., adjacent to second frame member 106. Fourth wheel 152 may be mounted at a rearward position in rear region 112 on second side 136 of chassis 102, i.e., adjacent to second frame member 106, and spaced apart from third wheel 150 to define second side saddle 170 therebetween. A hydraulic liquid tank 184 may be mounted to second frame member 106 on second side 136 of chassis 102 within second side saddle 170. Hydraulic liquid tank 184 may serve as a reservoir for containing excess hydraulic fluid for operation of mining truck 100 and/or serve to hold a supply of hydraulic fluid for operation of mining truck 100. A second liquid tank 186 is mounted to chassis 102 within second side saddle 170. In some embodiments, second liquid tank 186 may be an auxiliary hydrogen tank.

As illustrated, hydraulic liquid tank 184 may be mounted to chassis 102 at an interior position of second side saddle 170, while second liquid tank 186 may be mounted to chassis 102 at an exterior position of second side saddle 170, so that hydraulic liquid tank 184 is substantially in-between the chassis and the second liquid tank 186. In other embodiments, hydraulic liquid tank 184 and second liquid tank 186 may be alternately arranged. For example, in some embodiments, second liquid tank 186 may be mounted to chassis 102 at an interior position of second side saddle 170, while hydraulic liquid tank 184 may be mounted to chassis 102 at an exterior position of second side saddle 170.

In yet other embodiments, hydraulic liquid tank 184 and second liquid tank 186 may be both arranged at a generally interior position of second side saddle 170 so that one of hydraulic liquid tank 184 and second liquid tank 186 is positioned at a forward position near third wheel 150, and the other of the hydraulic liquid tank 184 and second liquid tank 186 is positioned at a rearward position near fourth wheel 152. In some embodiments, a third liquid tank, for example, a second auxiliary hydrogen tank, may be mounted to the chassis 102 within the second side saddle 170. In other embodiments, the third liquid tank may be mounted to chassis 102 within the first side saddle 166 in place of or in tandem with primary hydraulic tank 234. While second liquid tank 186 and the third liquid tank are described as auxiliary hydrogen tanks above, such tanks may contain another fluid, such as, for example, fuel, including diesel, methanol, ammonia, or other fuels appropriate for fueling the fuel cell modules of the vehicle.

Rear region space 158 defined by chassis 102 between second wheel 148 and fourth wheel 152 may include a vehicle subsystem 160 mounted therein, such as an aftertreatment system, a heating system for a bed of mining truck 100, and/or an exhaust muffler as described above. In some embodiments rear region space 158 may remain empty of any vehicle subsystems. It is within the scope of the disclosure that other subsystems beyond those listed explicitly herein may be mounted within rear region space 158.

Fuel cell modules 224 and/or balance-of-plant modules 228 may be positioned within horse collar 116 and/or extend in front of and/or behind horse collar 116 of chassis 102. Fuel cell modules 224 and/or balance-of-plant modules 228 may be in first fuel cell arrangement 201 or second fuel cell arrangement 214 as discussed above in reference to FIGS. 3-5.

As discussed above, deck 122 may be supported at a forward position by chassis 102. Deck 122 may include a first region 188 associated with a first side of deck 122 corresponding with first side 132 of chassis 102 and a second region 190 associated with a second side of deck 122 corresponding with second side 136 of chassis 102. First region 188 and second region 190 are illustrated by dividing line “D”. An operator cab 192 may be arranged within second region 190 of deck 122. Operator cab 192 is configured to house an operator during operation of mining truck 100, along with controls necessary or desired for said operation of mining truck 100.

For example, mining truck 100 may include a thermal management system 200, which may include a radiator 202 and a thermal manager 204. In some embodiments, radiator 202 and thermal manager 204 may be integrated, i.e., one thermal management component may serve as both radiator 202 and thermal manager 204. In other embodiments, radiator 202 may service both the powertrain and DC/DC system 196, while thermal manager 204 only services battery module(s) 206. In yet other embodiments, radiator 202 may service engine 142, battery thermal manager 204 may service battery module(s) 206, and a third thermal manager or heat exchanger (not shown) may service DC/DC system 196.

As illustrated, radiator 202 may be mounted to a front of mining truck 100, or, in other words, at a full forward position relative to deck 122. For example, radiator 202 may be mounted at the first end portion of chassis 102 adjacent the first end of chassis 102. In some embodiments, radiator 202 may be, at least in part, mounted to a forward edge of deck 122 so that radiator 202 extends downward from deck 122. In other embodiments, radiator 202 may be mounted to a front of mining truck 100 below deck 122. In yet other embodiments, radiator 202 may be mounted at another position of mining truck 100. An air cleaner may be integrated with or positioned immediately adjacent to radiator 202 to mitigate the presence of dirt, dust, and other contaminants.

A resistor grid 194 may be arranged within first region 188 of deck 122 and may be positioned at a generally rearward position of first region 188 of deck 122. Thermal manager 204 may be positioned forward of resistor grid 194, with DC/DC system 196 positioned forward for thermal manager 204, so that thermal manager 204 is positioned generally between resistor grid 194 and DC/DC system 196. The positioning of the components herein provides access to service panels on top of resistor grid 194, while further accounting for positioning of thermal manager 204 in an efficient position relative to DC/DC system 196. The arrangement of the components as described herein may also mitigate interference with line-of-sight mirrors (not shown) of mining truck 100 from operator cab 192 positioned within second region 190 of deck 122.

An inverter cabinet may be positioned at least partially in first region 188 of deck 122 and at least partially in second region 190 of deck 122. For example, inverter cabinet 198 may be equally positioned in first region 188 and second region 190 or, in some embodiments, be positioned so that a majority of inverter cabinet 198 is in first region 188. In other embodiments, inverter cabinet 198 may be positioned so that a majority of inverter cabinet 198 is in second region 190. As illustrated, inverter cabinet 198 may be positioned within a rear portion of deck 122. The positioning of inverter cabinet 198 in this manner may provide an open area for positioning of additional mining truck components, such as an on-board trolley system for use with an overhead trolley.

The arrangement of components on the deck as described herein are exemplary in nature and may be altered within the scope of the disclosure. For example, in some embodiments, first region 188 and second region 190 may be mirrored or switched. In other embodiments, components may be move relative to one another and/or relative to deck 122. For example, in some embodiments, DC/DC system 196 may be positioned on top of resistor grid 194 so that DC/DC system 196 and resistor grid 194 are in a vertically stacked arrangement. Other arrangements of components are within the scope of the disclosure.

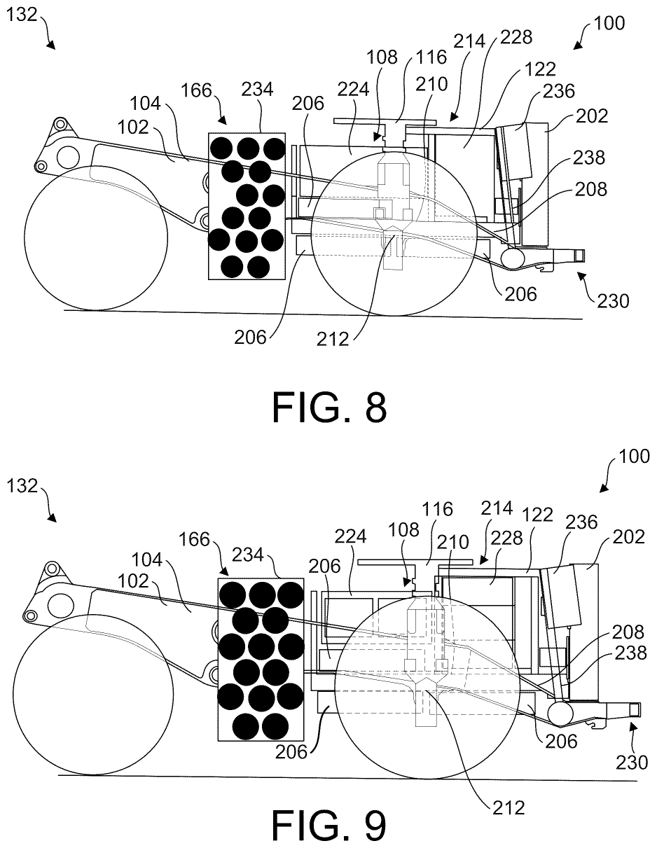

Now referring to FIG. 8, an exemplary architecture of mining truck 100 is illustrated from first side 132 of chassis 102 and mining truck 100. As discussed above in relation to the exemplary architecture illustrated in FIGS. 7A-7B, primary hydrogen tank 234 may be positioned within first side saddle 166 and mounted to, for example, first frame member 104 of chassis 102. Radiator 202 may be mounted at the forward-most position of deck 122, i.e., at a first end portion of chassis 102 adjacent the first end of chassis 102, and, for example, adjacent to a forward-most edge of deck 122 so that radiator 202 extends downward over front end 230 of mining truck 100. An air cleaner 236 may be positioned behind radiator 202 between radiator 202 and a fuel cell arrangement as described further herein; the air cleaner 236 configured to mitigate the presence of contaminants near the fuel cell arrangement. One or more electric fans 238 may also be positioned between radiator 202 and the fuel cell arrangement to assist with thermal management of the fuel cell arrangement and/or other components of mining truck 100.

The fuel cell arrangement illustrated in FIG. 8 may be consistent with fuel cell arrangement 214 as described above in relation to FIGS. 4A-4D. For example, fuel cell modules) 224 are arranged on one or more battery module(s) 206 positioned on top surface 210 of power module support frame 208. Fuel cell module(s) 224 may be arranged so that they are received within horse collar 116 of chassis 102 as described further herein, while remotely arranged balance-of-plant module(s) 228 are positioned at a forward position relative to horse collar 116. As illustrated, one or more battery module(s) 206 may also be mounted to bottom surface 212 of power module support frame 208. Fuel cell module(s) 224, balance-of-plant module(s) 228, and battery module(s) 206 may be mounted to power module support frame 208, which is then received within horse collar 116 of chassis 102 and mounted to chassis 102 so that the fuel cell module(s) 224, balance-of-plant module(s) 228, and battery module(s) 206 are arranged relative to mining truck 100 as illustrated and further described above.

Battery module(s) 206, balance-of-plant module(s) 228, and fuel cell module(s) 224 may be mounted to power module support frame 208, which is then loaded into position relative to chassis 102 and mounted to chassis 102 between first frame member 104 and second frame member 106 (FIG. 1), i.e., within space 108. Power module support frame 208 may extend through horse collar 116 of chassis 102 so that power module support frame 208 extends forward of horse collar 116 and rearward of horse collar 116. Power module support frame 208 may provide a mounting surface for battery module(s) 206, fuel cell module(s) 224, and balance-of-plant module(s) 228, thereby providing support to said components and/or to other components as discussed further herein in reference with other exemplary architectures. Power module support frame 208 may be shaped and sized to fit within space 108 of chassis 102 and therefore may further provide a footprint for the arrangement of components to be mounted within space 108 of mining truck 100 in this and other exemplary architectures as discussed further herein.

Referring to FIG. 9, another exemplary architecture of mining truck 100 is illustrated from first side 132 of chassis 102 and mining truck 100. Similar to architectures described above, primary hydrogen tank 234 may be positioned within first side saddle 166 and mounted to, for example, first frame member 104 of chassis 102. Radiator 202 may be mounted at the forward-most position of deck 122, i.e., at a first end portion of chassis 102 adjacent the first end of chassis 102, and, for example, adjacent to a forward-most edge of deck 122 so that radiator 202 extends downward over front end 230 of mining truck 100. Air cleaner 236 may be positioned behind radiator 202 between radiator 202 and a fuel cell arrangement as described further herein. Air cleaner 236 may be configured to mitigate the presence of contaminants near the fuel cell arrangement. One or more electric fans 238 may also be positioned between radiator 202 and the fuel cell arrangement to assist with thermal management of the fuel cell arrangement and/or other components of mining truck 100.

The fuel cell arrangement illustrated in FIG. 9 may include a remote balance-of-plant module arrangement similar to that of fuel cell arrangement 214 (FIGS. 4A-4D) or an integrated fuel cell arrangement similar to that of fuel cell arrangement 201 (FIG. 3). A first set 240 of fuel cell modules 224 and balance-of-plant modules 228 may be arranged at a forward position of power module support frame 208 with a second set 242 of fuel cell modules 224 and balance-of-plant modules 228 arranged at a rearward position of power module support frame 208.

First set 240 may be mounted to top surface 210 of power module support frame 208 with balance-of-plant modules 228 positioned at the forward-most position of power module support frame 208 and corresponding fuel cell modules 224 extending rearward from balance-of-plant modules 228. Second set 242 may be mounted to a first layer of battery module(s) 206 mounted to top surface 210 of power module support frame 208, with corresponding balance-of-plant modules 228 positioned adjacent to one of first member 104 and second member 106 (FIG. 1) of chassis 102 and corresponding fuel cell modules 224 extending toward the other of first member 104 and second member 106 (FIG. 1) of chassis 102. As illustrated, one or more battery module(s) 206 may also be mounted to bottom surface 212 of power module support frame 208. Fuel cell modules 224, balance-of-plant modules 228, and battery module(s) 206 may be mounted to power module support frame 208, which is then received within horse collar 116 of chassis 102 and mounted to chassis 102 so that the fuel cell modules 224, balance-of-plant modules 228, and battery module(s) 206 are arranged relative to mining truck 100 as illustrated and further described above.

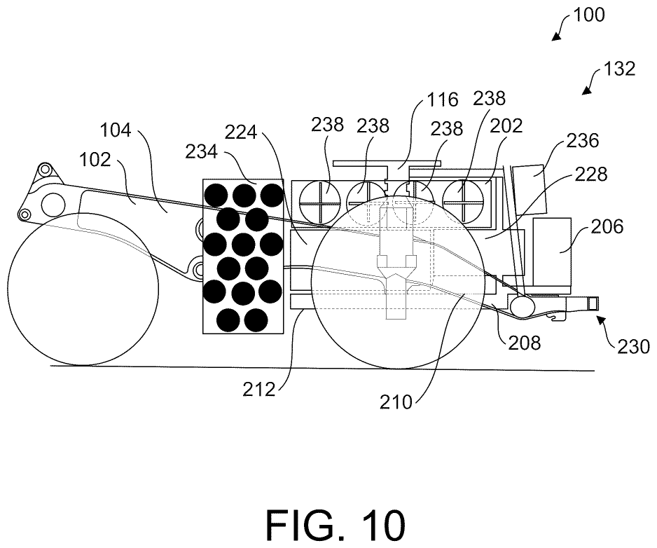

Another exemplary architecture of mining truck 100 is illustrated in FIG. 10 from first side 132 of chassis 102 and mining truck 100. Similar to architectures described above, primary hydrogen tank 234 may be positioned within first side saddle 166 and mounted to, for example, first frame member 104 of chassis 102. Battery module(s) 206 may be mounted to front end 230 of mining truck 100 and, e.g., at a forward-most position of mining truck 100 and/or at the first end portion of the chassis 102, and/or adjacent to the first end of the chassis 102. Air cleaner 236 may be positioned above and/or behind battery module(s) 206 adjacent to radiator 202 and/or a fuel cell arrangement as described further herein. Air cleaner 236 may be configured to mitigate the presence of contaminants near the fuel cell arrangement.

The fuel cell arrangement illustrated in FIG. 10 may include a remote balance-of-plant module arrangement similar to that of fuel cell arrangement 214 (FIGS. 4A-4D). Similar to fuel cell arrangement 214 (FIGS. 4A-4D), balance-of-plant module(s) 228 may be positioned at a forward position of power module support frame 208 and mounted to top surface 210 of power module support frame 208. Corresponding fuel cell module(s) 224 may be positioned rearward of balance-of-plant modules 228 and mounted to top surface 210 of power module support frame 208 so that balance-of-plant module(s) 228 are positioned forward of horse collar 116 and fuel cell stack(s) are positioned within and rearward of horse collar 116.

Radiator 202 may be mounted on top of fuel cell module(s) 224 and/or balance-of-plant module(s) 228. In some embodiments, radiator 202 may be angled relative to fuel cell module(s) 224 to define a triangular space between radiator 202 and fuel cell module(s) 224. In some embodiments, radiator 202 and fuel cell module(s) 224 may define an angle of about 20°, 30°, 40°, 45°, 50°, 60°, 70°, or any angle therebetween. In some embodiments, the angle defined between radiator 202 and fuel cell module(s) 224 may be lesser than 20° or greater than 70°.

Electric fans 238 may be arranged adjacent to radiator 202 and mounted on top of fuel cell module(s) 224 and/or balance-of-plant module(s) 228. For example, electric fans 238 may be arranged adjacent to radiator 202 on first side 132 of chassis 102 as shown. In other embodiments, electric fans 238 may be arranged adjacent radiator 202 on second side 136 (FIG. 1) of chassis 102 in addition to or instead of first side 132 of chassis 102. Electric fans 238 may assist with thermal management of the fuel cell arrangement and/or other components of mining truck 100. In some embodiments, additional battery module(s) may be mounted to a bottom surface of power module support frame 208.

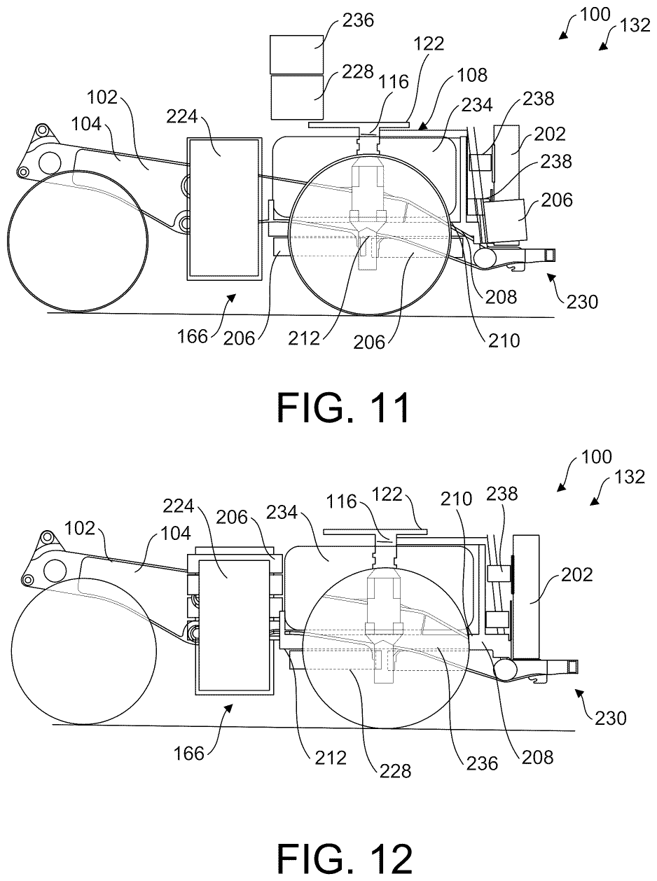

Referring to FIG. 11, another exemplary architecture of mining truck 100 is illustrated from first side 132 of chassis 102 and mining truck 100. As illustrated, primary hydrogen tank 234 may be mounted to top surface 210 of power module support frame 208 and positioned within and extending forward and/or rearward from horse collar 116 of chassis 102. Battery module(s) 206 may be mounted to bottom surface 212 of power module support frame 208. With primary hydrogen tank 234 positioned within space 108 of chassis 102, fuel cell module(s) 224 may be mounted within first side saddle 166 and mounted to, for example, first frame member 104 of chassis 102. In some embodiments, fuel cell(s) may be packaged in a fuel cell stack module similar to a battery pack module as illustrated and described in co-pending U.S. Application filed on the same day as the present disclosure and entitled “XXXX”. The positioning of fuel cell module(s) 224 within first side saddle 166 may provide the same benefits and advantages as the positioning of the primary hydrogen tank within the first side saddle as described above.

Radiator 202 may be mounted to the forward-most position of deck 122 i.e., at a first end portion of chassis 102 adjacent the first end of chassis 102, and, for example, adjacent to a forward-most edge of deck 122 so that radiator 202 extends downward over front end 230 of mining truck 100. One or more electric fans 238 may be positioned between radiator 202 and primary hydrogen tank 234 to assist with thermal management of components of mining truck 100. Additional battery module(s) 206 may be arranged adjacent to radiator 202. For example, battery module(s) 206 may be arranged next to radiator 202 on first side 132 of chassis 102 as illustrated. In other embodiments, additional battery module(s) 206 may also or alternately be arranged next to radiator 202 on second side 136 (FIG. 1) of chassis 102.

Balance-of-plant module(s) 228 may be mounted on deck 122 and have a remote arrangement with corresponding fuel cell module(s) 224 mounted within first side saddle 166 of mining truck 100. Air cleaner 236 may be positioned on top of balance-of-plant module(s) 228 as illustrated. In other embodiments, air cleaner 236 may be alternately arranged on deck 122 or positioned in another arrangement relative to mining truck 100. Air cleaner 236 may be configured to mitigate the presence of contaminants near balance-of-plant module(s) 228 and/or fuel cell module(s) 224.

FIG. 12 illustrates another exemplary architecture of mining truck 100 from first side 132 of chassis 102 and mining truck 100. As with the exemplary architecture of FIG. 11 described above, primary hydrogen tank 234 may be mounted to top surface 210 of power module support frame 208 and positioned within and extending forward and/or rearward from horse collar 116 of chassis 102. Balance-of-plant module(s) 228 may be mounted to bottom surface 212 of power module support frame 208. Air cleaner 236 may be mounted to bottom surface 212 of power module support frame 208 at a forward position relative to balance-of-plant module(s) 228 and be configured to mitigate the presence of contaminants.

Fuel cell module(s) 224 may be mounted within first side saddle 166 and mounted to, for example, first frame member 104 of chassis 102, fuel cell module(s) 224 having a remote arrangement with corresponding balance-of-plant module(s) 228 mounted to bottom surface 212 of power module support frame 208. In some embodiments, fuel cell(s) may be packaged in a fuel cell module similar to a battery pack module as described above.

Battery module(s) 206 may be mounted within second side saddle 170 (FIG. 1) and mounted to, for example, second frame member 106 (FIG. 1) of chassis 102, either directly or via hydraulic liquid tank 184 as described in relation to FIGS. 7A-7C above; in other words, battery module(s) 206 may be positioned similarly and/or in place of second liquid tank 186 (FIGS. 7A-7C) described above. Battery module(s) 206 may be packaged in a battery pack module similar to that illustrated and described in co-pending U.S. Application filed on the same day as the present disclosure and entitled “XXXX”. The positioning of battery module(s) 206 within second side saddle 170 (FIG. 1) may provide the same benefits and advantages as the positioning of the second liquid tank within the second side saddle as described above.

Radiator 202 may be mounted to the forward-most position of deck 122 i.e., at a first end portion of chassis 102 adjacent the first end of chassis 102, and, for example, adjacent to forward-most edge of deck 122 so that radiator 202 extends downward over front end 230 of mining truck 100. One or more electric fans 238 may be positioned between radiator 202 and primary hydrogen tank 234 to assist with thermal management of components of mining truck 100.

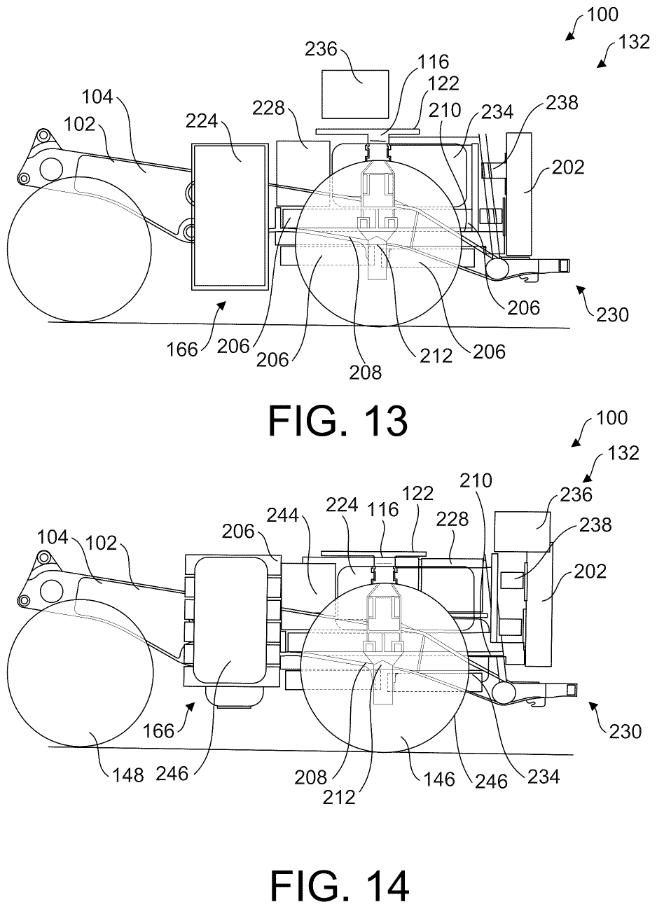

Yet another exemplary architecture of mining truck 100 is illustrated in FIG. 13, wherein the exemplary architecture is illustrated from a view of first side 132 of chassis 102 and mining truck 100. As illustrated, a first layer of battery module(s) 206 may be mounted to top surface 210 of power module support frame 208. Primary hydrogen tank 234 may be mounted to the first layer of battery module(s) 206 at a forward position of power module support frame 208 so that primary hydrogen tank 234 is positioned within horse collar 116 of chassis 102 and extends forward of horse collar 116. In some embodiments, such as the one illustrated, primary hydrogen tank 234 may also extend rearward of horse collar 116, although primary hydrogen tank 234 may extend further toward a forward position of horse collar 116 than toward a rearward position of horse collar 116. Balance-of-plant module(s) 228 may also be mounted to the first layer of battery module(s) 206 at a rearward position of power module support frame 208 relative to primary hydrogen tank 234. An additional layer of battery module(s) 206 may be mounted to bottom surface 212 of power module support frame 208 as illustrated. However, in some embodiments, there may not be battery module(s) mounted to the bottom surface of the power module support frame and/or to the top surface of the power module support frame.

Fuel cell module(s) 224 may be mounted within first side saddle 166 and mounted to, for example, first frame member 104 of chassis 102, fuel cell module(s) 224 having a remote arrangement with corresponding balance-of-plant module(s) 228 mounted to power module support frame 208 as described above. In some embodiments, fuel cell(s) 224 may be packaged in a fuel cell stack module similar to a battery pack module as described above. Radiator 202 may be mounted to a forward-most position of deck 122 i.e., at a first end portion of chassis 102 adjacent the first end of chassis 102, and, for example, adjacent to forward-most edge of deck 122 so that radiator 202 extends downward over front end 230 of mining truck 100. One or more electric fans 238 may be positioned between radiator 202 and primary hydrogen tank 234 to assist with thermal management of components of mining truck 100. Air cleaner 236 may be mounted to deck 122 to mitigate the presence of contaminants. In some embodiments, air cleaner 236 may be mounted to an air duct inlet rather than directly to a surface of deck 122.

Now referring to FIG. 14, another exemplary architecture is illustrated from first side 132 of chassis 102 and mining truck 100. As illustrated, primary hydrogen tank 234 may be mounted to power module support frame 208, with fuel cell module(s) 224 and corresponding balance-of-plant module(s) 228 mounted above primary hydrogen tank 234 in a remote arrangement (i.e., similar to fuel cell arrangement 214 discussed above). In some embodiments, such as the one illustrated, primary hydrogen tank 234 may be mounted to one or more rails 245 of power module support frame 208 which extend at least a length of primary hydrogen tank 234.

Fuel cell module(s) 224 and balance-of-plant module(s) 228 may be mounted to a shelf structure 244 of power module support frame 208. In other embodiments, fuel cell modulek(s) 224 and corresponding balance-of-plant module(s) 228 may be mounted to primary hydrogen tank 234 or power module support frame 208 via other mechanisms. Power module support frame 208, primary hydrogen tank 234, fuel cell module(s) 224, and balance-of-plant module(s) 228 may be arranged relative to chassis 102 so that primary hydrogen tank 234 and fuel cell module(s) 224 extend through horse collar 116 of chassis 102 while balance-of-plant module(s) 228 are arranged at a forward position relative to fuel cell module(s) 224 and horse collar 116.

An additional hydrogen tank 246 may be mounted within first side saddle 166 and mounted to, for example, first frame member 104 of chassis 102. Battery module(s) 206 may be mounted within second side saddle 170 (FIG. 1) and mounted to, for example, second frame member 106 (FIG. 1) of chassis 102, either directly or via hydraulic liquid tank 184 as described in relation to FIGS. 7A-7C above; in other words, battery module(s) 206 may be positioned similarly and/or in place of second liquid tank 186 (FIGS. 7A-7C) described above. Battery module(s) 206 may be packaged in a battery pack module as described above. The positioning of battery module(s) 206 within second side saddle 170 (FIG. 1) may provide the same benefits and advantages as the positioning of the second liquid tank within the second side saddle as described above.

Some embodiments may not include additional hydrogen tank 246. In other words, additional hydrogen tank 246 may be optional and, in some embodiments, first side saddle 166 may remain an empty space between first wheel 146 and second wheel 148. In other embodiments, battery module(s) 206 may be mounted within first side saddle 166 while hydraulic liquid tank 184 (FIG. 7A) and/or second liquid tank 186 (FIG. 7A) remain in second side saddle 170 (FIG. 7A) to maintain the benefits and advantages of having components mounted within both the first side saddle and the second side saddle as discussed above.

Radiator 202 may be mounted to a forward-most position of deck 122 i.e., at a first end portion of chassis 102 adjacent the first end of chassis 102, and, for example, adjacent to forward-most edge of deck 122 so that radiator 202 extends downward over front end 230 of mining truck 100. One or more electric fans 238 may be positioned between radiator 202 and primary hydrogen tank 234 to assist with thermal management of components of mining truck 100. Air cleaner 236 may be mounted to deck 122 or otherwise adjacent to radiator 202 to mitigate the presence of contaminants.

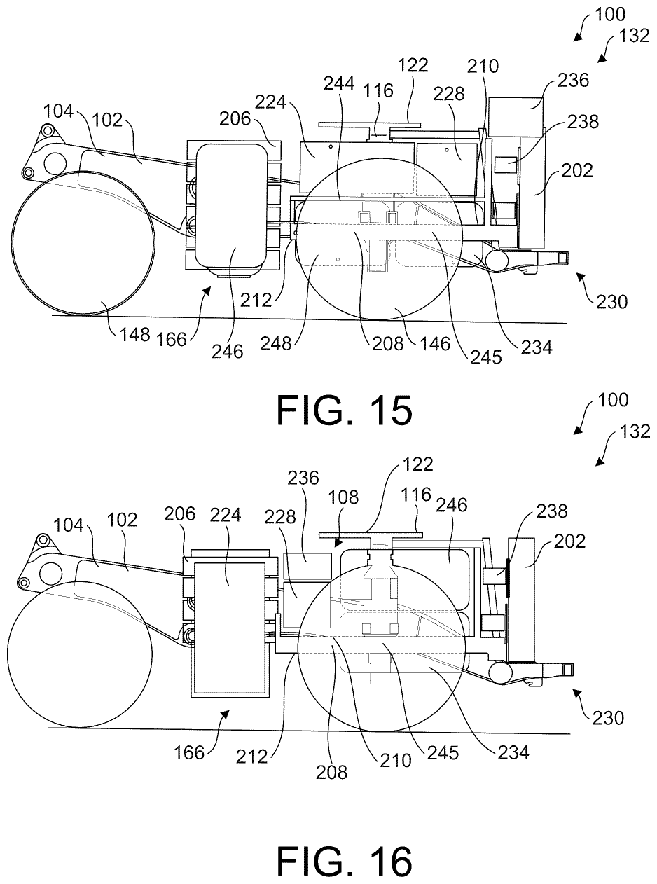

An exemplary architecture illustrated in FIG. 15 is similar to the architecture illustrated in FIG. 14, except that, instead of a single primary hydrogen tank, two hydrogen tanks, i.e., primary hydrogen tank 234 and a third hydrogen tank 248, are mounted to power module support frame 208 in a manner similar to primary hydrogen tank 234 in FIG. 14. In other words, primary hydrogen tank 234 may be mounted to power module support frame 208 at a forward position, additional hydrogen tank 246 may optionally be mounted in first side saddle 166 as discussed above, and third hydrogen tank 248 may be mounted to power module support frame 208 at a rearward position relative to primary hydrogen tank 234. In some embodiments, primary hydrogen tank 234 may be mounted at the rearward position while third hydrogen tank 248 is mounted at the forward position. Although third hydrogen tank 248 is described as a “third” hydrogen tank, in some embodiments, additional hydrogen tank 246 may not be included in the architecture. In other words, although described as a “third” hydrogen tank, in some arrangements, third hydrogen tank 248 may be one of two hydrogen tanks within the architecture.

Splitting the arrangement of primary hydrogen tank 234 as illustrated in FIG. 14 into primary hydrogen tank 234 and third hydrogen tank 248 as illustrated in FIG. 15 may increase the scalability and modularity of the arrangement for use in variously sized vehicles, whether mining trucks or other vehicles. The arrangement may further enable inclusion of extra hydrogen on board at any given time, may allow for faster filling of the hydrogen tanks, and may increase flexibility for battery technology and/or the exchange of components within the architecture. In addition, the serviceability of the arrangement may be improved in view of the more manageable size of the hydrogen tanks, including potentially increased inspection and maintenance capabilities.

FIG. 16 illustrates another exemplary architecture of mining truck 100 from first side 132 of chassis 102 and mining truck 100. As illustrated, primary hydrogen tank 234 may be mounted to power module support frame 208, with an additional hydrogen tank 246 mounted above primary hydrogen tank 234 in a vertical arrangement. In some embodiments, such as the one illustrated, primary hydrogen tank 234 may be mounted to one or more rails 245 of power module support frame 208 which extend at least a length of primary hydrogen tank 234. Additional hydrogen tank 246 may be mounted to primary hydrogen tank 234 or power module support frame 208. Power module support frame 208, primary hydrogen tank 234, and additional hydrogen tank 246 may be arranged relative to chassis 102 so that primary hydrogen tank 234 and additional hydrogen tank 246 extend through horse collar 116 of chassis 102. In some embodiments, primary hydrogen tank 234 and additional hydrogen tank 246 may switch positions. In other words, primary hydrogen tank 234 and additional hydrogen tank 246 may be positioned in a vertical arrangement so that primary hydrogen tank 234 is mounted above additional hydrogen tank 246 or so that additional hydrogen tank 246 is mounted above primary hydrogen tank 234.

Balance-of-plant module(s) 228 may be mounted to top surface 210 of power module support frame 208 at a rearward position relative to primary hydrogen tank 234 and additional hydrogen tank 246. As illustrated, balance-of-plant module(s) 228 may also be positioned rearward of horse collar 116 of chassis 102 within space 108. Air cleaner 236 may be mounted above balance-of-plant module(s) 228 to mitigate the presence of contaminants, either directly to balance-of-plant module(s) 228 or to power module support frame 208.

Fuel cell module(s) 224 may be mounted within first side saddle 166 and mounted to, for example, first frame member 104 of chassis 102, fuel cell module(s) 224 having a remote arrangement with corresponding balance-of-plant module(s) 228 mounted to top surface 210 of power module support frame 208. In some embodiments, fuel cell(s) may be packaged in a fuel cell stack module similar to a battery pack module as described above.

Battery module(s) 206 may be mounted within second side saddle 170 (FIG. 1) and mounted to, for example, second frame member 106 (FIG. 1) of chassis 102, either directly or via hydraulic liquid tank 184 as described in relation to FIGS. 7A-7C above; in other words, battery module(s) 206 may be positioned similarly and/or in place of second liquid tank 186 (FIGS. 7A-7C) described above. Battery module(s) 206 may be packaged in a battery pack module as described above. The positioning of battery module(s) 206 within second side saddle 170 (FIG. 1) may provide the same benefits and advantages as the positioning of the second liquid tank within the second side saddle as described above.

Radiator 202 may be mounted to the forward-most position of deck 122 i.e., at a first end portion of chassis 102 adjacent the first end of chassis 102, and, for example, adjacent to forward-most edge of deck 122 so that radiator 202 extends downward over front end 230 of mining truck 100. One or more electric fans 238 may be positioned between radiator 202 and primary hydrogen tank 234 to assist with thermal management of components of mining truck 100.

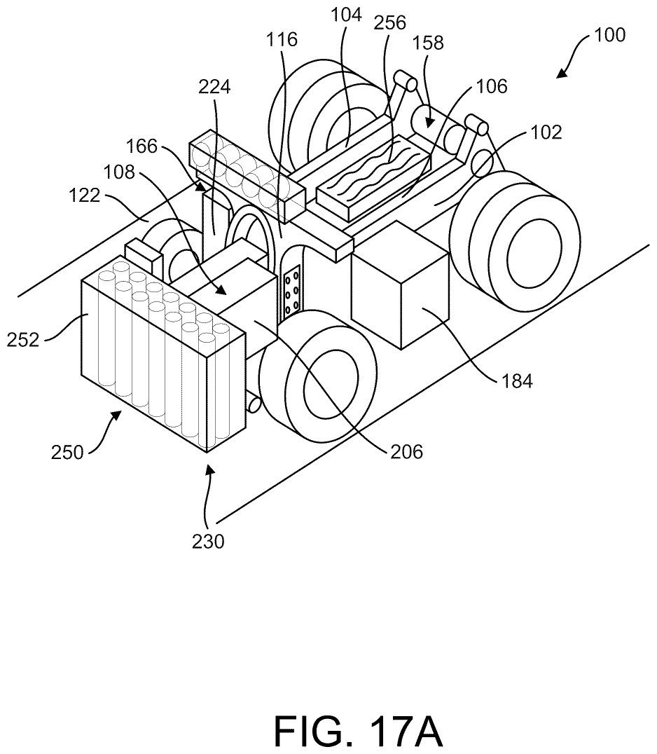

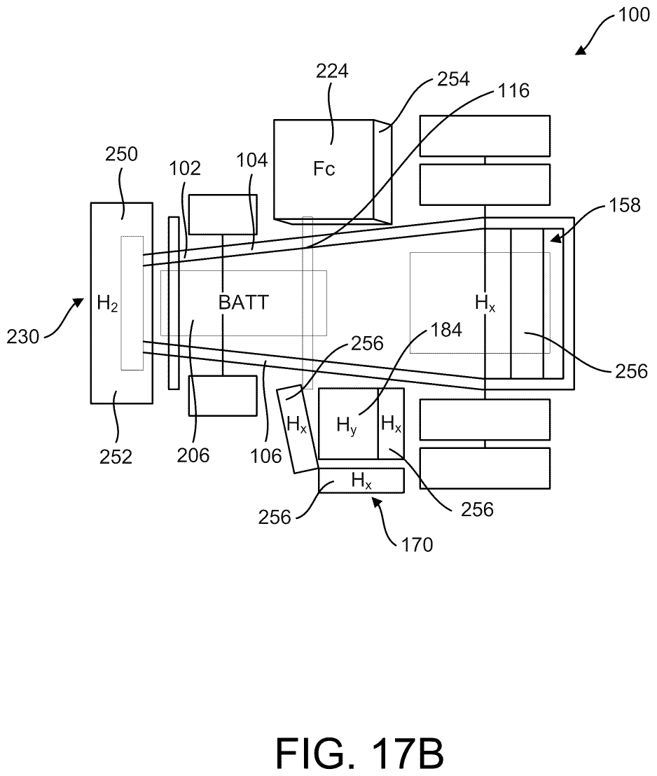

FIGS. 17A-17B illustrate a perspective view and a top schematic view, respectively of another exemplary architecture of mining truck 100, wherein one or more hydrogen tanks 250 (e.g., 234, 246, 248, and/or additional hydrogen tanks) are mounted to a front end 230 of mining truck 100 i.e., at a first end portion of chassis 102 adjacent the first end of chassis 102. The one or more hydrogen tanks 250 may be supported within a pack support 252 mounted to front end 230 of mining truck 100 via chassis 102 or deck 122. For example, in some embodiments, the one or more hydrogen tanks 250 and/or, in some embodiments, pack support 252, may be mounted adjacent to the forward-most position of deck 122 and, for example, to or adjacent to forward-most edge of deck 122 so that the one or more hydrogen tanks 250 and/or pack support 252 extends downward over front end 230 of mining truck 100.

Battery module(s) 206 may be positioned within space 108 between first member 104 and second member 106 of chassis 102 and, for example, within and/or extending forward and/or rearward of horse collar 116. In some embodiments, battery module(s) 206 may be mounted to a power module support frame as described above. In other embodiments, battery module(s) 206 may be mounted directly to chassis 102 or otherwise mounted into position via other mechanisms.

Fuel cell module(s) 224 may be mounted within first side saddle 166 and mounted to, for example, first frame member 104 of chassis 102. In some embodiments, fuel cell(s) may be packaged in a fuel cell stack module similar to a battery pack module as described above. A space 254 (FIG. 17B) may be provided rearward of fuel cell module(s) 224 to facilitate mounting of corresponding balance-of-plant module(s), a heat exchanger, and/or other components as discussed further herein.

Balance-of-plant module(s) may be integrated with fuel cell module(s) 224, packaged within a fuel cell stack module in a remote or integrated arrangement, arranged adjacent to fuel cell module(s) 224 (e.g., within space 254) in a remote arrangement, and/or otherwise arranged in a remote arrangement within the architecture of mining truck 100. Hydraulic liquid tank 184 may be mounted within second side saddle 170 and mounted to, for example, second frame member 106 of chassis 102. One or more heat exchangers 256 may be mounted within rear region space 158 of chassis 102 and/or surrounding hydraulic liquid tank 184 and/or adjacent to fuel cell module(s) 224 (e.g., within space 254).

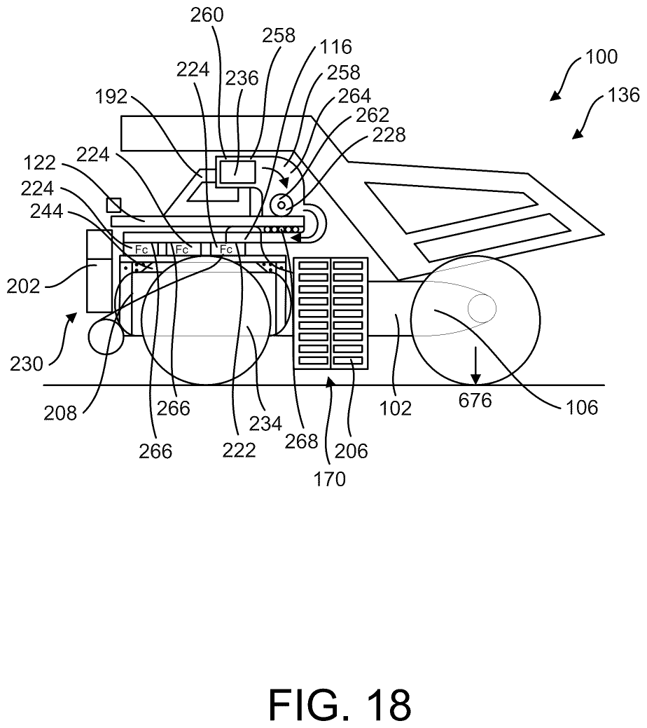

FIG. 18 illustrates an exemplary architecture of mining truck 100 from second side 136 of chassis 102 and mining truck 100. As illustrated, primary hydrogen tank 234 may be mounted to power module support frame 208, which may include an additional shelf structure 244 positioned above primary hydrogen tank 234 to support fuel cell module(s) 224 thereon. Primary hydrogen tank 234 and/or fuel cell module(s) 224 may be positioned within horse collar 116 of chassis 102 and may extend forward of and/or rearward of horse collar 116.

An air inlet assembly 258 may be structured and positioned to direct air from above deck 122 to fuel cell module(s) 224. For example, an air inlet scoop 260 may be mounted to operator cab 192 or another position on or above deck 122 to encourage flow of air into air inlet assembly 258. Air cleaner 236 may be mounted to the entrance of or within the entrance of air inlet scoop 260 to mitigate the presence of contaminants within the air provided to fuel cell module(s) 224. In some embodiments, air cleaner 236 may be positioned in an alternate position within air inlet assembly 258. One or more air pumps 262 may be positioned within a body 264 of air inlet assembly 258 to facilitate movement of air through air inlet assembly 258. Balance-of-plant module(s) 228 may also be arranged with air pump(s) 262 within body 264 of air inlet assembly 258. One or more outlets 266 may be positioned adjacent to each fuel cell module 224 to facilitate connection of the corresponding balance-of-plant module 228 to the respective fuel cell module 224 and delivery of air to each fuel cell module 224. An exhaust 268 may be disposed between air inlet assembly 258 and deck 122.

Battery module(s) 206 may be mounted within second side saddle 170 and mounted to, for example, second frame member 106 of chassis 102, either directly or via hydraulic liquid tank 184 as described in relation to FIGS. 7A-7C; in other words, battery module(s) 206 may be positioned similarly and/or in place of second liquid tank 186 (FIGS. 7A-7C) described above. Battery module(s) 206 may be packaged in a battery pack module as described above. In some other embodiments, battery module(s) 206 may otherwise be mounted in first side saddle 166 (FIG. 1). In yet other embodiments, the first side saddle may remain empty, or another component or additional liquid tank may be mounted therein.

Radiator 202 may be mounted to the forward-most position of deck 122, i.e., at a first end portion of chassis 102 adjacent the first end of chassis 102, and, for example, adjacent to forward-most edge of deck 122 so that radiator 202 extends downward over front end 230 of mining truck 100. One or more electric fans may be positioned between radiator 202 and primary hydrogen tank 234 and/or fuel cell module(s) 224 to assist with thermal management of components of mining truck 100 as described above.

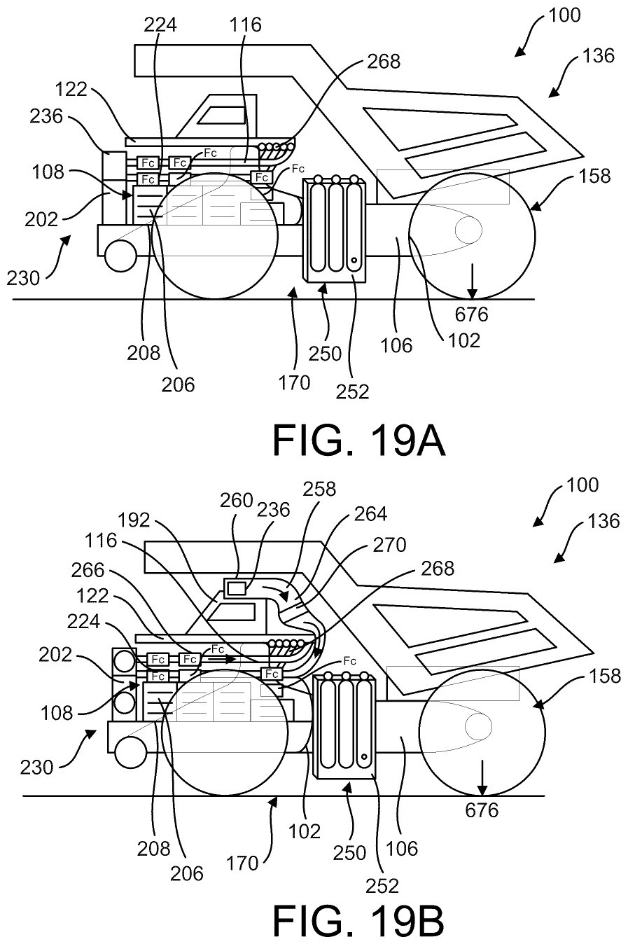

FIG. 19A-19B illustrates another exemplary architecture of mining truck 100 from second side 136 of chassis 102 and mining truck 100. As illustrated, battery module(s) 206 may be mounted within space 108 between first frame member 104 (FIG. 1) and second frame member 106 of chassis 102. Battery module(s) 206 may be mounted to power module support frame 208 positioned within chassis 102 as described. Fuel cell modules 224 are mounted above battery module(s) 206 and may be mounted directly to battery module(s) 206 and/or to power module support frame 208 via other mechanisms. Fuel cell modules 224 and/or battery module(s) 206 may be positioned within horse collar 116 of chassis 102 and may extend forward of and/or rearward of horse collar 116. Exhaust 268 may be disposed between deck 122 and fuel cell modules 224.

One or more hydrogen tanks 250 (e.g., hydrogen tanks 234, 246, 248, and/or other hydrogen tanks) may be mounted within second side saddle 170. In some embodiments, the one or more hydrogen tanks 250 may be packaged within pack support 252 as described above. The one or more hydrogen tanks 250 and/or pack support 252 may be mounted to, for example, second frame member 106 of chassis 102, either directly or via hydraulic liquid tank 184 as described in relation to FIGS. 7A-7C; in other words, the one or more hydrogen tanks 250 may be positioned similarly and/or in place of second liquid tank 186 (FIGS. 7A-7C) described above. In some other embodiments, the one or more hydrogen tanks 250 and/or pack support 252 may otherwise be mounted in first side saddle 166 (FIG. 1). In yet other embodiments, the first side saddle may remain empty, or another component or additional liquid tank may be mounted therein as described further herein. A heat exchanger, similar to heat exchanger 256 described above, and/or a DC/DC system, similar to DC/DC system 196 described above, may be mounted within rear region space 158 of chassis 102.

Radiator 202 may be mounted to the forward-most position of deck 122, i.e., at a first end portion of chassis 102 adjacent the first end of chassis 102, and, for example, adjacent to forward-most edge of deck 122 so that radiator 202 extends downward over front end 230 of mining truck 100. One or more electric fans may be positioned between radiator 202 and battery module(s) 206 and/or fuel cell stack(s) 224 to assist with thermal management of components of mining truck 100 as described above.

As shown in FIG. 19A, in some embodiments, air cleaner 236 may be mounted adjacent to radiator 202. In other embodiments, as shown in FIG. 19B, mining truck 100 may include an air inlet assembly 258, similar to that described above. For example, an air inlet scoop 260 may be mounted to operator cab 192 or another position on or above deck 122 to encourage flow of air into air inlet assembly 258. Air cleaner 236 may be mounted to the entrance of or within the entrance of air inlet scoop 260 to mitigate the presence of contaminants within the air provided to fuel cell module(s) 224. In some embodiments, air cleaner 236 may be positioned in an alternate position within air inlet assembly 258. A second filter 270, such as a carbon or chemical filter, may be positioned within a body 264 of air inlet assembly 258. One or more outlets 266 may be positioned adjacent to each fuel cell module 224 to facilitate delivery of air to each fuel cell module 224.

Balance-of-plant module(s) may be integrated with fuel cell module(s) 224 similar to fuel cell arrangement 201 described above. In other embodiments, balance-of-plant module(s) may be arranged within the architecture of mining truck 100 in a remote arrangement with corresponding fuel cell module(s) 224. The balance-of-plant module(s) may be positioned, for example, on deck 122, mounted on or under power module support frame 208, within first side saddle 166 (FIG. 1), within second side saddle 170, or any other available position relative to mining truck 100.

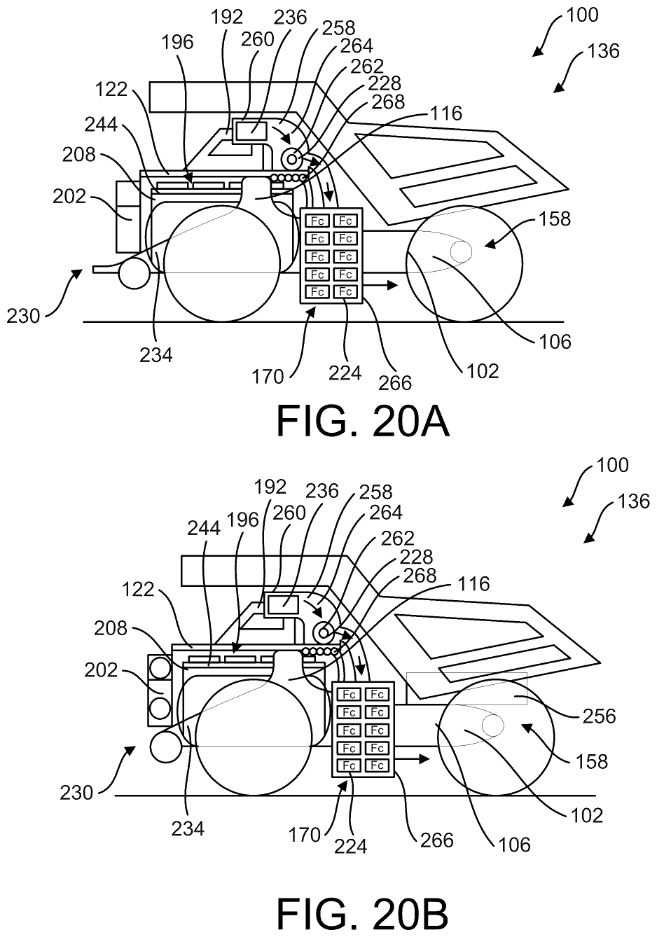

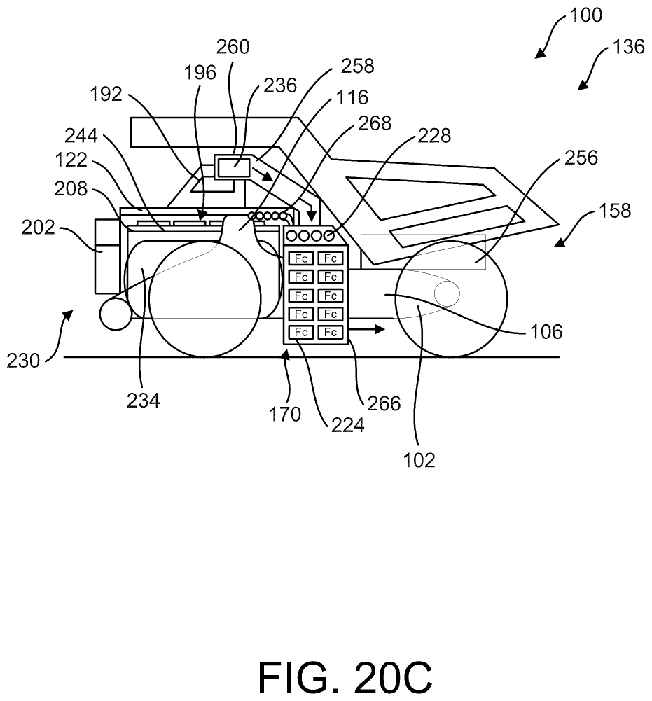

FIG. 20A-20C illustrates another exemplary architecture of mining truck 100 from second side 136 of chassis 102 and mining truck 100. As illustrated, primary hydrogen tank 234 may be mounted to power module support frame 208, which may include an additional shelf structure 244 positioned above primary hydrogen tank 234 to support DC/DC system 196 thereon. Primary hydrogen tank 234 and/or DC/DC system 196 may be positioned within horse collar 116 of chassis 102 and may extend forward of and/or rearward of horse collar 116. An exhaust 268 may be disposed between deck 122 and DC/DC system 196.

Fuel cell module(s) 224 may be mounted within second side saddle 170 and mounted to, for example, second frame member 106 of chassis 102, either directly or via hydraulic liquid tank 184 as described in relation to FIGS. 7A-7C; in other words, fuel cell module(s) 224 may be positioned similarly and/or in place of second liquid tank 186 (FIGS. 7A-7C) described above. Fuel cell(s) 224 may be packaged in a fuel cell pack module similar to a battery pack module as described above. In some other embodiments, fuel cell module(s) 224 may otherwise be mounted in first side saddle 166 (FIG. 1). In yet other embodiments, the first side saddle may remain empty, or another component or additional liquid tank may be mounted therein.

An air inlet assembly 258 may be structured and positioned to direct air from above deck 122 to fuel cell module(s) 224. For example, an air inlet scoop 260 may be mounted to operator cab 192 or another position on or above deck 122 to encourage flow of air into air inlet assembly 258. Air cleaner 236 may be mounted to the entrance of or within the entrance of air inlet scoop 260 to mitigate the presence of contaminants within the air provided to fuel cell module(s) 224. In some embodiments, air cleaner 236 may be positioned in an alternate position within air inlet assembly 258. As shown in FIGS. 20A-20B, in some embodiments, one or more air pumps 262 may be positioned within a body 264 of air inlet assembly 258 to facilitate movement of air through air inlet assembly 258. Balance-of-plant module(s) 228 may also be arranged with air pump(s) 262 within body 264 of air inlet assembly 258. In other embodiments, as shown in FIG. 20C, balance-of-plant module(s) 228 may be remotely arranged above fuel cell module(s) 224 in a centralized position relative to fuel cell module(s) 224 and air inlet assembly 258. Referring again to all of FIGS. 20A-20C, one or more outlets 266 may be positioned adjacent to each fuel cell module(s) 224 to facilitate delivery of air to each fuel cell module 224.

Radiator 202 may be mounted to the forward-most position of deck 122, i.e., at a first end portion of chassis 102 adjacent the first end of chassis 102, and, for example, adjacent to forward-most edge of deck 122 so that radiator 202 extends downward over front end 230 of mining truck 100. One or more electric fans may be positioned between radiator 202 and primary hydrogen tank 234 and/or DC/DC system 196 to assist with thermal management of components of mining truck 100 as described above. A heat exchanger, similar to heat exchanger 256 described above, may be mounted within rear region space 158 of chassis 102.

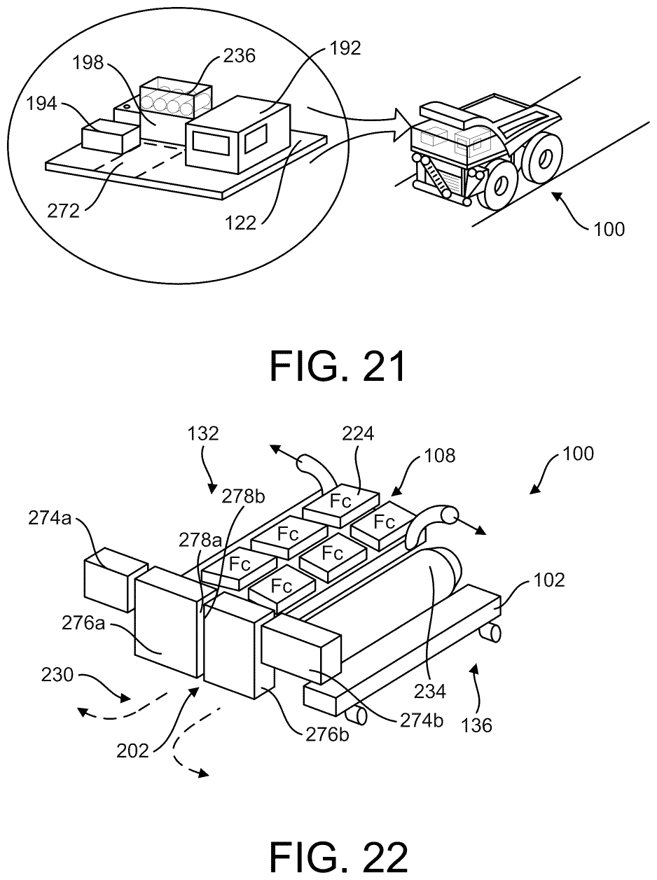

In any of the architectures described herein, access to components contained within the space defined by the first and second members of the chassis facilitates outfitting of the mining truck, as well as serviceability and/or replacement of components as needed. Referring to FIG. 21, such access may be provided via deck 122. As shown and described above, deck 122 may support a number of components and/or subsystems for operation of mining truck 100. For example, operator cab 192, resistor grid 194, inverter cabinet 198, air filter(s) 236 and/or a number of other components and/or subsystems may be arranged on deck 122 as illustrated in FIG. 21 or otherwise positioned as described above. Deck 122 may further define an access panel 272 at a forward position of deck 122, which may be configured to open to allow access to components and/or subsystems mounted to chassis 102 (FIG. 1) as described above.

Now referring to FIG. 22, access to components and/or subsystems mounted to chassis 102 may be provided via radiator 202. For example, in many embodiments described herein, radiator 202 is mounted adjacent to the forward-most position of deck 122 (FIG. 1) and/or adjacent to forward-most edge of deck 122 (FIG. 1) so that radiator 202 extends downward over front end 230 of mining truck 100. In such embodiments, radiator 202 may be a hinged radiator. As shown in FIG. 22, radiator 202 may include a first mounting section 274a fixedly mounted to deck 122 (FIG. 1) or front end 230 of mining truck 100 at a position corresponding with first side 132 of chassis 102 and/or mining truck 100. First mounting section 274a may be pivotally coupled to a first hinged section 276a so that first hinged section 276a may pivot outwardly, or away from mining truck 100, relative to first mounting section 274a. Radiator 202 may further include a second mounting section 274b fixedly mounted to deck 122 (FIG. 1) or front end 230 of mining truck 100 at a position corresponding with second side 136 of chassis 102 and/or mining truck 100. Second mounting section 274b may be pivotally coupled to a second hinged section 276b so that second hinged section 276b may be pivot outwardly, or away from mining truck 100, relative to second mounting section 274b.

As such, first hinged section 276a and second hinged section 276b may open outwardly to provide access to the components and/or subsystems positioned within space 108 of chassis 102. When closed, an edge 278a of first hinged section 276a and an edge 278b of second hinged section 276b may rest adjacent to each other to enclose the components and/or subsystems positioned within space 108 of chassis 102 behind said first hinged section 276a and second hinged section 276b. In some embodiments, radiator 202 may include a locking mechanism (not shown) to prevent undesired opening of first hinged section 276a and second hinged section 276b.

While FIG. 22 illustrates the positioning of primary hydrogen tank 234 and fuel cell modules 224 within space 108 of chassis 102, it is understood that hinged radiator 202 may be applied to any architecture of mining truck 100 wherein radiator 202 is positioned at the first end portion and/or adjacent to the front end of chassis 102, regardless of what components and/or subsystems are positioned within space 108 of chassis 102.

While the system and methods herein have been described by reference to various specific embodiments it should be understood that numerous changes may be made within the spirit and scope of the concepts described, accordingly, it is intended that the invention is not limited to the described embodiments but will have full scope defined by the language of the following claims.

Various aspects are described in this disclosure, which include, but are not limited to, the following aspects:
(1) A mining haul truck, including: a vehicle chassis having a first end portion with a first end and a second end portion with a second end, the vehicle chassis including a first longitudinal member extending from the first end to the second end and a second longitudinal member extending from the first end to the second end, the first longitudinal member and the second longitudinal member defining a vehicle chassis space therebetween; a first wheel coupled to the first longitudinal member at a first forward position; a second wheel coupled to the first longitudinal member at a first rearward position, the first wheel and the second wheel defining a side saddle therebetween; a third wheel coupled to the second longitudinal member at a second forward position; a fourth wheel coupled to the second longitudinal member at a second rearward position, the third wheel and the fourth wheel defining a second side saddle therebetween; a power module support frame coupled to a forward position of the vehicle chassis; and a first fluid tank positioned within the vehicle chassis space defined by the first longitudinal member and the second longitudinal member and supported by the power module support frame.
(2) The mining haul truck of Aspect (1), further including a hydraulic fluid tank positioned in the second side saddle and mounted to the vehicle chassis.
(3) The mining haul truck of Aspect (2), wherein the first battery module is positioned between the power module support frame and the fluid tank.
(4) The mining haul truck of any one of Aspects (1)-(2), further including a fuel cell module positioned in one of the first side saddle and the second side saddle and coupled to the vehicle chassis; and a battery module positioned in the other of the first side saddle and the second side saddle and coupled to the vehicle chassis.
(5) The mining haul truck of any one of Aspects (1)-(2), further including a battery module positioned within the vehicle chassis space and supported by the power module support frame.
(6) The mining haul truck of any one of Aspects (1)-(2), further including a battery module positioned within the first end portion of the vehicle chassis on or adjacent to the first end of the vehicle chassis.
(7) The mining haul truck of any one of Aspects (1)-(2), further including a battery module positioned in one of the first side saddle and the second side saddle and mounted to the vehicle chassis.
(8) The mining haul truck of any one of Aspects (1)-(7), further including a fuel cell module positioned in the second side saddle and coupled to the vehicle chassis.
(9) The mining haul truck of any one of Aspects (1)-(7), further including a fuel cell module positioned within the vehicle chassis space adjacent to the first fluid tank.
(10) The mining haul truck of Aspect (9), wherein the fuel cell module is positioned between the power module support frame and the fluid tank.
(11) The mining haul truck of Aspect (9), wherein the fuel cell module is in a vertical arrangement with the first fluid tank so that the fuel cell module is arranged above the first fluid tank.
(12) The mining haul truck of any one of Aspects (1)-(7), further including a fuel cell module positioned in the first side saddle and mounted to the vehicle chassis.
(13) The mining haul truck of any one of Aspects (1)-(12), further including a deck supported by the first end portion of the vehicle chassis; and a balance-of-plant module supported by the deck.
(14) The mining haul truck of Aspect (13), further including an air cleaner supported by the balance-of-plant module.
(15) The mining haul truck of any one of Aspects (1)-(12), further including a balance-of-plant module positioned within the vehicle chassis space and supported by at least one of the power module support frame and the first fluid tank.
(16) The mining haul truck of Aspect (15), wherein the balance-of-plant module is positioned between the power module support frame and the first fluid tank.
(17) The mining haul truck of Aspect (15), wherein the balance-of-plant module is positioned in a rearward position relative to the fluid tank.
(18) The mining haul truck of any one of Aspects (1)-(17), further including an air cleaner positioned within the vehicle chassis space and supported by at least one of the power module support frame and the first fluid tank.
(19) The mining haul truck of Aspect (18), wherein the air cleaner is supported by a balance-of-plant module, the balance-of-plant module supported by one of the power module support frame and the first fluid tank.
(20) The mining haul truck of any one of Aspects (1)-(19), wherein the first fluid tank contains one of methanol and ammonia.
(21) The mining haul truck of any one of Aspects (1)-(19), wherein the first fluid tank is a hydrogen tank.
(22) The mining haul truck of any one of Aspects (1)-(21), further including a second fluid tank positioned within one of the first side saddle, the second side saddle, and adjacent to the first fluid tank in the vehicle chassis space.
(23) The mining haul truck of Aspect (22), wherein the second fluid tank is positioned adjacent to the first fluid tank within the vehicle chassis space and the first fluid tank and the second fluid tank are in a vertical arrangement.
(24) The mining haul truck of Aspect (22), further including a third fluid tank positioned within another one of the first side saddle, the second side saddle, and adjacent to the first fluid tank in the vehicle chassis space.
(25) The mining haul truck of Aspect (22), wherein the first fluid tank contains a first fluid and the second fluid tank contains a second fluid different than the first fluid.
(26) The mining haul truck of any one of Aspects (1)-(25), further including a radiator positioned at the first end portion of the vehicle chassis adjacent the first end of the vehicle chassis.
(27) The mining haul truck of Aspect (26), wherein the radiator is hingedly coupled to the mining haul truck.
(28) The mining haul truck of Aspect (26), further including a plurality of fans positioned between the radiator and the first fluid tank.
(29) The mining haul truck of any one of Aspects (1)-(28), further including a deck supported by a first end portion of the vehicle chassis; and an air cleaner supported by the deck adjacent to the first end of the chassis.
(30) The mining haul truck of any one of Aspects (1)-(29), further including a deck supported by a first end portion of the vehicle chassis; and a resistor grid supported by the deck.
(31) The mining haul truck of any one of Aspects (1)-(30), further including a deck supported by a first end portion of the vehicle chassis; and an inverter cabinet supported by the deck.
(32) The mining haul truck of any one of Aspects (1)-(31), wherein the first fluid tank is cylindrical.
(33) The mining haul truck of any one of Aspects (1)-(32), further including a DC/DC system positioned in the vehicle chassis space in a vertical arrangement with the first fluid tank so that the DC/DC system is above the first fluid tank.
(34) The mining haul truck of any one of Aspects (1)-(33), further including a rear chassis space defined between the second wheel and the fourth wheel; and a heat exchanger positioned in the rear chassis space.
(35) The mining haul truck of any one of Aspects (1)-(34), further including a deck supported by a first end portion of the vehicle chassis, the deck defining an access panel to selectively provide access to the vehicle chassis space.
(36) The mining haul truck of any one of Aspects (1)-(35), further including a heat exchanger positioned within the first end portion of the vehicle chassis adjacent to the front end of the vehicle chassis.
(37) A mining haul truck, including: a vehicle chassis having a first end portion with a first end and a second end portion with a second end, the vehicle chassis including a first longitudinal member extending from the first end to the second end and a second longitudinal member extending from the first end to the second end, the first longitudinal member and the second longitudinal member defining a vehicle chassis space therebetween; a power module support frame coupled to a forward position of the vehicle chassis; a first fluid tank positioned within the vehicle chassis space defined by the first longitudinal member and the second longitudinal member and mounted to a lower portion of the power module support frame; a fuel cell module positioned within the vehicle chassis space and supported by an upper portion of the power module support frame; and a balance-of-plant module positioned within the vehicle chassis space and supported by the upper portion of the power module support frame.
(38) The mining haul truck of Aspect (37), further including: a first wheel coupled to the first longitudinal member at a first forward position; a second wheel coupled to the first longitudinal member at a first rearward position, the first wheel and the second wheel defining a side saddle therebetween; and a battery module positioned within the first side saddle and mounted to the vehicle chassis.
(39) The mining haul truck of Aspect (38), further including: a third wheel coupled to the second longitudinal member at a second forward position; a fourth wheel coupled to the second longitudinal member at a second rearward position, the third wheel and the fourth wheel defining a second side saddle therebetween; a hydraulics tank positioned within the second side saddle and mounted to the vehicle chassis; and a second fluid tank positioned within the second side saddle and mounted to the vehicle chassis.
(40) The mining haul truck of Aspect (39), wherein at least one of the first fluid tank and the second fluid tank is a hydrogen tank.
(41) The mining haul truck of Aspect (39), wherein at least one of the first fluid tank and the second fluid tank contains one of methanol and ammonia.
(42) The mining haul truck of any one of Aspects (37)-(41), further including a deck supported by the first end portion of the vehicle chassis and an air cleaner supported by the deck.
(43) A mining haul truck, including: a vehicle chassis having a first end portion with a first end and a second end portion with a second end, the vehicle chassis including a first longitudinal member extending from the first end to the second end and a second longitudinal member extending from the first end to the second end, the first longitudinal member and the second longitudinal member defining a vehicle chassis space therebetween; a power module support frame positioned within the vehicle chassis space and coupled to the vehicle chassis; a first battery module supported by the power module support frame; a first fuel cell module positioned within the vehicle chassis space and supported by the power module support frame in a vertical arrangement with the first battery module so that the first fuel cell module is positioned above the first battery module; and a first balance-of-plant module positioned on the power module support frame and operably connected to the first fuel cell module.
(44) The mining haul truck of Aspect (43), further including a first wheel coupled to the first longitudinal member at a forward position and a second wheel coupled to the first longitudinal member at a rearward position, the first wheel and the second wheel defining a side saddle therebetween; and a fluid tank positioned within the first side saddle and coupled to the first longitudinal member.
(45) The mining haul truck of Aspect (44), wherein the fluid tank contains one of methanol and ammonia.
(46) The mining haul truck of Aspect (44), wherein the fluid tank is a hydrogen tank.
(47) The mining haul truck of any one of Aspects (43)-(46), further including a second battery module positioned within the vehicle chassis space and supported by the power module support frame.
(48) The mining haul truck of Aspect (47), further including: a second fuel cell module positioned within the vehicle chassis space and supported by the power module support frame in a vertical arrangement with the second battery module so that the second fuel cell module is positioned above the second battery module; and a second balance-of-plant module positioned within the vehicle chassis space, supported by the power module support frame, and connected to the second fuel cell module.
(49) The mining haul truck of Aspect (47), wherein the first battery module is coupled to a top surface of the power module support frame and the second battery module is coupled to a bottom surface of the power module support frame.
(50) The mining haul truck of any one of Aspects (43)-(49), wherein the first balance-of-plant module is integrated with the first fuel cell module.
(51) The mining haul truck of any one of Aspects (43)-(49), wherein the first balance-of plant module is spaced apart from the first fuel cell module.
(52) The mining haul truck of Aspect (51), wherein the first balance-of-plant module is positioned at a forward position relative to the first fuel cell stack.
(53) The mining haul truck of any one of Aspects (43)-(49), further including a deck supported by the first end portion of the vehicle chassis; and a radiator positioned adjacent a forwardmost position of the deck.
(54) The mining haul truck of Aspect (53), further including a plurality of fans positioned adjacent to the radiator.
(55) The mining haul truck of Aspect (53), further including an air cleaner positioned between the radiator and the first balance-of-plant module.
(56) A mining haul truck, including: a vehicle chassis having a first end portion with a first end and a second end portion with a second end, the vehicle chassis including a first longitudinal member extending from the first end to the second end and a second longitudinal member extending from the first end to the second end, the first longitudinal member and the second longitudinal member defining a vehicle chassis space therebetween; a power module support frame positioned within the vehicle chassis space and coupled to the vehicle chassis; a fuel cell module positioned within the vehicle chassis space and supported by the power module support frame; a balance-of-plant module positioned within the vehicle chassis space, connected to the fuel cell module, and supported by the power module support frame; and a radiator positioned within the vehicle chassis space and supported by the power module support frame, the radiator positioned in a vertical arrangement with the fuel cell module and the balance-of-plant module so that the radiator is positioned above the fuel cell module and the balance-of-plant module.
(57) The mining haul truck of Aspect (56), further including a first wheel coupled to the first longitudinal member at a forward position and a second wheel coupled to the first longitudinal member at a rearward position, the first wheel and the second wheel defining a side saddle therebetween; and a fluid tank positioned within the side saddle and coupled to the first longitudinal member.
(58) The mining haul truck of Aspect (57), wherein the fluid tank contains one of methanol and ammonia.
(59) The mining haul truck of Aspect (57), wherein the fluid tank is a hydrogen tank.
(60) The mining haul truck of any one of Aspects (56)-(59), further including a battery module positioned at a first end portion of the vehicle chassis adjacent the first end of the vehicle chassis.
(61) The mining haul truck of any one of Aspects (56)-(60), further including an air cleaner positioned at a first end portion of the vehicle chassis adjacent the first end of the vehicle chassis.
(62) The mining haul truck of any one of Aspects (56)-(61), further including a plurality of fans positioned adjacent to the radiator.
(63) A mining haul truck including: a vehicle chassis having a first end portion with a first end and a second end portion with a second end, the vehicle chassis having a first longitudinal member extending from the first end portion to the second end portion and a second longitudinal member extending from the first end portion to the second end portion, the first longitudinal member and the second longitudinal member defining a vehicle chassis space therebetween; a first wheel coupled to the first longitudinal member at a forward position; a second wheel coupled to the first longitudinal member at a rearward position, the first wheel and the second wheel defining a side saddle therebetween; a deck supported by the first end portion of the vehicle chassis; and a battery module positioned within the first end portion of the vehicle chassis adjacent the first end of the vehicle chassis.
(64) The mining haul truck of Aspect (63), further including a fluid tank positioned within the side saddle and coupled to the vehicle chassis.
(65) The mining haul truck of Aspect (64), wherein the fluid tank contains one of methanol and ammonia.
(66) The mining haul truck of Aspect (64), wherein the fluid tank is a hydrogen tank.
(67) The mining haul truck of any one of Aspects (63)-(66), further including an air cleaner positioned within the first end portion of the vehicle chassis adjacent the first end of the vehicle chassis.
(68) The mining haul truck of any one of Aspects (63)-(67), further including a fuel cell module positioned within the vehicle chassis space.
(69) The mining haul truck of Aspect (68), further including a balance-of-plant module connected to the fuel cell module and positioned within the vehicle chassis space.
(70) The mining haul truck of Aspect (69), further including a radiator positioned in a vertical arrangement with the fuel cell module and the balance-of-plant module so that the radiator is above the fuel cell module and the balance-of-plant module.
(71) The mining haul truck of Aspect (70), wherein the radiator is angled relative to the fuel cell module to define a triangular space between the fuel cell module and the radiator.
(72) The mining haul truck of Aspect (71), wherein an angle defined between the radiator and the fuel cell module is 30°-45°.
(73) The mining haul truck of Aspect (70), further including a plurality of fans positioned adjacent to the radiator.
(74) The mining haul truck of any one of Aspects (68)-(73), further including a second battery module positioned within the vehicle chassis space.
(75) The mining haul truck of Aspect (74), further including a hydrogen tank positioned in vertical arrangement with the second battery module so that the hydrogen tank is above the second battery module.
(76) The mining haul truck of any one of Aspects (63)-(75), further including a fluid tank positioned within the vehicle chassis space.
(77) The mining haul truck of Aspect (76), wherein the fluid tank contains one of methanol and ammonia.
(78) The mining haul truck of Aspect (76), wherein the fluid tank is a hydrogen tank.
(79) The mining haul truck of any one of Aspects (63)-(78), further including a balance-of-plant module supported by the deck.
(80) The mining haul truck of Aspect (79), further including an air cleaner supported by the balance-of-plant module.
(81) The mining haul truck of any one of Aspects (63)-(78), further including a radiator positioned at the first end portion of the vehicle chassis adjacent to the first end of the vehicle chassis.
(82) The mining haul truck of any one of Aspects (63)-(79), further including a fuel cell module positioned within the side saddle and coupled to the vehicle chassis.
(83) A mining haul truck, including: a vehicle chassis having a first end portion with a first end and a second end portion with a second end, the vehicle chassis including a first longitudinal member extending from the first end to the second end and a second longitudinal member extending from the first end to the second end, the first longitudinal member and the second longitudinal member defining a vehicle chassis space therebetween; a power module support frame positioned within the vehicle chassis space and coupled to the vehicle chassis; a first battery module supported by the power module support frame; and a second battery module positioned at the first end portion of the vehicle chassis adjacent the first end of the vehicle chassis.
(84) The mining haul truck of Aspect (83), further including a first wheel coupled to the first longitudinal member at a forward position and a second wheel coupled to the first longitudinal member at a rearward position, the first wheel and the second wheel defining a side saddle therebetween; and a fuel cell module positioned in the side saddle and coupled to the vehicle chassis.
(85) The mining haul truck of any one of Aspects (83)-(84), further including a fluid tank positioned within the vehicle chassis space in a vertical arrangement with the first battery module so that the fluid tank is above the first battery module.
(86) The mining haul truck of Aspect (85), wherein the fluid tank contains one of methanol and ammonia.
(87) The mining haul truck of Aspect (85), wherein the fluid tank is a hydrogen tank.
(88) The mining haul truck of any one of Aspects (83)-(87), further including a deck supported by the first end portion of the vehicle chassis and a balance-of-plant module supported by the deck.
(89) The mining haul truck of Aspect (88), further including an air cleaner supported by the balance-of-plant module.
(90) The mining haul truck of any one of Aspects (83)-(89), further including a radiator positioned at the first end portion of the vehicle chassis adjacent the first end of the vehicle chassis.
(91) A mining haul truck, including: a vehicle chassis having a first end portion with a first end and a second end portion with a second end, a first longitudinal member extending from the first end portion to the second end portion and a second longitudinal member extending from the first end portion to the second end portion, the first longitudinal member and the second longitudinal member defining a vehicle chassis space therebetween; a first wheel coupled to the first longitudinal member at a first forward position; a second wheel coupled to the first longitudinal member at a first rearward position, the first wheel and the second wheel defining a first side saddle therebetween; a third wheel coupled to the second longitudinal member at a second forward position; a fourth wheel coupled to the second longitudinal member at a second rearward position, the third wheel and the fourth wheel defining a second side saddle therebetween, and the second wheel and the fourth wheel defining a rear chassis space therebetween; and a fluid tank mounted at the first end portion of the vehicle chassis adjacent to the first end of the vehicle chassis.
(92) The mining haul truck of Aspect (91), further including a battery module mounted in the vehicle chassis space.
(93) The mining haul truck of any one of Aspects (91)-(92), further including a fuel cell module positioned in one of the first side saddle and the second side saddle and coupled to the vehicle chassis.
(94) The mining haul truck of Aspect (93), further including a hydraulic tank positioned in the other of the first side saddle and the second side saddle and coupled to the vehicle chassis.
(95) The mining haul truck of any one of Aspects (91)-(94), further including a heat exchanger positioned in the rear chassis space and coupled to the vehicle chassis.
(96) A method of assembling a mining haul truck having a vehicle chassis including a first longitudinal member extending from a first end of the vehicle chassis to a s second end of the vehicle chassis, the method including: mounting a first battery module on a power module support frame within a vehicle chassis space defined between the first longitudinal member and the second longitudinal member; positioning a first fuel cell module in a vertical arrangement with the first battery module so that the first fuel cell module is supported by the power module support frame above the first battery module.
(97) The method of Aspect (96), wherein the mining haul truck further includes a first wheel coupled to the first longitudinal member at a forward position and a second wheel coupled to the first longitudinal member at a rearward position, the method further including: mounting a fluid tank to the first longitudinal member within the first side saddle.
(98) The method of Aspect (97), wherein the fluid tank contains one of methanol and ammonia.
(99) The method of Aspect (97), wherein the fluid tank is a hydrogen tank.
(100) The method of any one of Aspects (96)-(99), further including mounting a second battery module to the power module support frame within the vehicle chassis space.
(101) The method of Aspect (100), further including mounting a second fuel cell module in a vertical arrangement with the second battery module so that the second fuel cell module is supported by the power module support frame above the second battery module.
(102) The method of Aspect (101), further including positioning a balance-of-plant module within the vehicle chassis space so that the balance-of-plant module is supported by the power module support frame.
(103) The method of Aspect (100), wherein the step of mounting the first battery module includes mounting the first battery module to a top surface of the power module support frame, and the step of mounting the second battery module includes mounting the second battery module to a bottom surface of the power module support frame.
(104) The method of any one of Aspects (96)-(103), wherein the mining haul truck further includes a balance-of-plant module integrated with the first fuel cell module.
(105) The method of any one of Aspects (96)-(103), further including positioning a balance-of-plant module in a position spaced-apart from the first fuel cell module.
(106) The method of Aspect (105), wherein positioning the balance-of-plant module includes positioning the balance-of-plant module in a forward position relative to the first fuel cell module.
(107) The method of any one of Aspects (96)-(106), wherein the mining haul truck further includes a deck supported by a first end portion of the vehicle chassis, the first end portion associated with the first end of the vehicle chassis, and the method further includes mounting a radiator to the mining truck adjacent to a forwardmost position of the deck.
(108) The method of Aspect (107), further including mounting a plurality of fans to the mining truck adjacent to the radiator.
(109) The method of any one of Aspects (107)-(108), further including mounting an air cleaner to the mining haul truck between the radiator and a balance-of-plant module.
(110) The method of any one of Aspects (96)-(109), further including positioning a balance-of-plant module associated with the first fuel cell module in a vertical arrangement with the power module support frame so that the balance-of-plant module is supported by the power module support frame.
(111) A method of assembling a mining haul truck having a vehicle chassis including a first longitudinal member extending from a first end of the vehicle chassis to a second end of the vehicle chassis and a second longitudinal member extending from the first end of the vehicle chassis to the second end of the vehicle chassis, the method including: mounting a fuel cell module to a power module support frame within a vehicle chassis space defined between the first longitudinal member and the second longitudinal member; mounting a balance-of-plant module to the power module support frame; and positioning a radiator in a vertical arrangement with the fuel cell module and the balance-of-plant module so that the radiator is supported by the power module support frame above the fuel cell module and the balance-of-plant module.
(112) The method of Aspect (111), wherein the mining haul truck further includes a first wheel coupled to the first longitudinal member at a forward position and a second wheel coupled to the first longitudinal member at a rearward position, the method further including: mounting a fluid tank to the vehicle chassis within a side saddle defined between the first wheel and the second wheel.
(113) The method of Aspect (112), wherein the fluid tank contains one of methanol and ammonia.
(114) The method of Aspect (112), wherein the fluid tank is a hydrogen tank.
(115) The method of any one of Aspects (111)-(114), further including mounting a battery module to the mining truck at a first end portion of the chassis adjacent to the first end of the vehicle chassis.
(116) The method of any one of Aspects (111)-(115), further including mounting an air cleaner to the mining truck at a first end portion of the chassis adjacent to the first end of the vehicle chassis.
(117) The method of any one of Aspects (111)-(116), further including positioning a plurality of fans so that the plurality of fans is supported by the power module support frame adjacent to the radiator.
(118) A method of assembling a mining haul truck having a vehicle chassis with a first end portion with a first end and a second end portion with a second end, the vehicle chassis including a first longitudinal member extending from the first end portion to the second end portion and a second longitudinal member extending from the first end portion to the second end portion, a vehicle chassis space defined between the first longitudinal member and the second longitudinal member, the mining haul truck further having a first wheel coupled to the first longitudinal member at a forward position and a second wheel coupled to the first longitudinal member at a rearward position, a side saddle defined between the first wheel and the second wheel and a deck supported by the first end portion of the vehicle chassis; the method including: mounting a battery module to the first end portion of the vehicle chassis adjacent to the first end of the vehicle chassis.
(119) The method of Aspect (118), further including mounting a fluid tank to the vehicle chassis within a side saddle defined between the first wheel and the second wheel.
(120) The method of Aspect (119), wherein the fluid tank contains one of methanol and ammonia.
(121) The method of Aspect (119), wherein the fluid tank is a hydrogen tank.
(122) The method of any one of Aspects (118)-(121), further including mounting an air cleaner to the first end portion.
(123) The method of any one of Aspects (118)-(122), further including mounting a fuel cell module to a power module support frame coupled to the vehicle chassis within the vehicle chassis space.
(124) The method of Aspect (123), further including mounting a balance-of-plant module to the power module support frame within the vehicle chassis space.
(125) The method of Aspect (124), further including positioning a radiator in a vertical arrangement with the fuel cell module and the balance-of-plant module so that the radiator is supported by the power module support frame above the fuel cell module and the balance-of-plant module.
(126) The method of Aspect (125), wherein positioning the radiator further includes angling the radiator relative to the fuel cell module to define a triangular space between the fuel cell module and the radiator.
(127) The method of Aspect (126), wherein an angle defined between the radiator and the fuel cell module is 30°-45°.
(128) The method of any one of Aspects (125)-(126), further including positioning a plurality of fans so that the plurality of fans is supported by the power module support frame adjacent to the radiator.
(129) The method of any one of Aspects (123)-(128), further including mounting a second battery module to the power module support frame within the vehicle chassis space.
(130) The method of Aspect (129), further including positioning a hydrogen tank in a vertical arrangement with the second battery module so that the hydrogen tank is supported by the power module support frame above the second battery module.
(131) The method of any one of Aspects (118)-(130), further including mounting a fluid tank to the power module support frame within the vehicle chassis space.
(132) The method of Aspect (131), wherein the fluid tank contains one of methanol and ammonia.
(133) The method of Aspect (131), wherein the fluid tank is a hydrogen tank.
(134) The method of any one of Aspects (118)-(133), further including mounting a balance-of-plant module to the deck.
(135) The method of Aspect (134), further including positioning an air cleaner so that the air cleaner is supported by the balance-of-plant module.
(136) The method of any one of Aspects (118)-(135), further including mounting a radiator to the front end portion of the vehicle chassis adjacent the first end of the vehicle chassis.
(137) The method of any one of Aspects (118)-(136), further including mounting a fuel cell module to the vehicle chassis within the side saddle.
(138) A method of assembling a mining haul truck having a vehicle chassis including a first longitudinal member extending from a first end of the vehicle chassis to a second end of the vehicle chassis and a second longitudinal member extending from the first end of the vehicle chassis to the second end of the vehicle chassis, the first end of the vehicle chassis supporting a deck, the method including: mounting a first battery module to a power module support frame coupled to the vehicle chassis within a vehicle chassis space defined between the first longitudinal member and the second longitudinal member; and mounting a second battery module at a first end portion of the vehicle chassis adjacent to the first end of the vehicle chassis.
(139) The method of Aspect (138), wherein the mining haul truck includes a first wheel coupled to the first longitudinal member at a forward position and a second wheel coupled to the first longitudinal member at a rearward position, the method further including: mounting a fuel cell module to the vehicle chassis within a side saddle defined between the first wheel and the second wheel.
(140) The method of any one of Aspects (138)-(139), further including positioning a fluid tank in vertical arrangement with the first battery module so that the fluid tank is supported by the power module support frame above the first battery module.
(141) The method of Aspect (140), wherein the fluid tank contains one of methanol and ammonia.
(142) The method of Aspect (140), wherein the fluid tank is a hydrogen tank.
(143) The method of any one of Aspects (138)-(142), further including mounting a balance-of-plant module on the deck.
(144) The method of Aspect (143), further including positioning an air cleaner so that the air cleaner is supported by the balance-of-plant module.
(145) The method of any one of Aspects (138)-(144), further including mounting a radiator at a first end portion of the vehicle chassis adjacent the first end of the vehicle chassis.
(146) A method of assembling a mining haul truck, the method including: mounting a power module support frame to a forward portion of a vehicle chassis of the mining haul truck, the vehicle chassis including a first longitudinal member extending from a first end of the vehicle chassis to a second end of the vehicle chassis and a second longitudinal member extending from the first end of the vehicle chassis to the second end of the vehicle chassis; and positioning a first fluid tank within a vehicle chassis space defined between the first longitudinal member and the second longitudinal member so that the first fluid tank is supported by the power module support frame; wherein the mining haul truck further includes: a deck supported by a first end portion of the vehicle chassis associated with the first end of the vehicle chassis; a first wheel coupled to the first longitudinal member at a first forward position; a second wheel coupled to the first longitudinal member at a first rearward position, the first wheel and the second wheel defining a first side saddle therebetween; a third wheel coupled to the second longitudinal member at a second forward position; and a fourth wheel coupled to the second longitudinal member at a second rearward position, the third wheel and the fourth wheel defining a second side saddle therebetween.
(147) The method of Aspect (146), further including positioning a first battery module within the vehicle chassis space so that the first battery module is supported by the power module support frame.
(148) The method of Aspect (147), wherein positioning the first battery module includes positioning the first battery module between the power module support frame and the fluid tank.
(149) The method of any one of Aspects (147)-(148), further including mounting a second battery module adjacent to the first end of the vehicle chassis.
(150) The method of any one of Aspects (146)-(149), wherein the fluid tank contains one of methanol and ammonia.
(151) The method of any one of Aspects (146)-(149), wherein the fluid tank is a hydrogen tank.
(152) The method of any one of Aspects (146)-(151), further including positioning a balance-of-plant module within the vehicle chassis space so that the balance-of-plant module is supported by the power module support frame.
(153) The method of Aspect (152), wherein positioning the balance-of-plant module includes positioning the balance-of-plant module between the power module support frame and the fluid tank.
(154) The method of any one of Aspects (152)-(153), wherein positioning the balance-of-plant module includes positioning the balance-of-plant module so that the balance-of-plant module is further supported by the fluid tank.
(155) The method of any one of Aspects (152)-(154), wherein positioning the balance-of-plant module includes positioning the balance-of-plant module so that the balance-of-plant module is rearward relative to the fluid tank.
(156) The method of Aspect (155), further including positioning an air cleaner so that the air cleaner is supported by the balance-of-plant module.
(157) The method of any one of Aspects (146)-(156), further including mounting a fuel cell module to the vehicle chassis within at least one of the first side saddle and the second side saddle.
(158) The method of any one of Aspects (146)-(157), further including mounting a battery module to the vehicle chassis within at least one of the first side saddle and the second side saddle.
(159) The method of any one of Aspects (146)-(158), further including mounting a fuel cell module to the vehicle chassis within one of the first side saddle and the second side saddle; and mounting a battery module to the vehicle chassis in the other of the first side saddle and the second side saddle.
(160) The method of any one of Aspects (146)-(159), further including mounting a second fluid tank within one of the first side saddle, the second side saddle, and the vehicle chassis space in a position adjacent to the first fluid tank.
(161) The method of Aspect (160), further including mounting the second fluid tank within the vehicle chassis space in a position adjacent to the first fluid tank so that the first fluid tank and the second fluid tank are in a vertical arrangement.
(162) The method of any one of Aspects (160)-(161), further including mounting a third fluid tank within another of the first side saddle, the second side saddle, and the vehicle chassis space adjacent to the first fluid tank.
(163) The method of any one of Aspects (160)-(162), wherein the first fluid tank contains a first fluid and the second fluid tank contains a second fluid different than the first fluid.
(164) The method of any one of Aspects (146)-(163), further including mounting a radiator adjacent the first end of the vehicle chassis.
(165) The method of Aspect (164), wherein mounting the radiator includes hingedly mounting the radiator.
(166) The method of any one of Aspects (164)-(165), further including positioning a plurality of fans between the radiator and the first fluid tank.
(167) The method of any one of Aspects (146)-(166), further including mounting a balance-of-plant module on the deck.
(168) The method of Aspect (167), further including positioning an air cleaner so that the air cleaner is supported by the balance-of-plant module.
(169) The method of any one of Aspects (146)-(168), further including mounting a fuel cell module within the vehicle chassis space adjacent to the first fluid tank so that the fuel cell stack is supported by the power module support frame.
(170) The method of Aspect (169), wherein mounting the fuel cell module includes positioning the fuel cell module so that the fuel cell module is also supported by the fluid tank.
(171) The method of any one of Aspects (169)-(170), wherein mounting the fuel cell module includes positioning the fuel cell module so that the fuel cell module is also supported by the fluid tank.
(172) The method of any one of Aspects (169)-(171), wherein mounting the fuel cell module includes positioning the fuel cell module between the power module support frame and the fluid tank.
(173) The method of any one of Aspects (146)-(172), further including mounting an air cleaner on the deck adjacent to the first end of the chassis.
(174) The method of any one of Aspects (146)-(173), further including mounting a resistor grid on the deck.
(175) The method of any one of Aspects (146)-(174), further including mounting an inverter cabinet on the deck.
(176) The method of any one of Aspects (146)-(175), wherein the fluid tank is cylindrical.
(177) The method of any one of Aspects (146)-(176), further including mounting a DC/DC system within the vehicle chassis space in a vertical arrangement with the fluid tank so that the DC/DC system is positioned above the fluid tank and supported by the power module support frame.
(178) The method of any one of Aspects (146)-(177), further including mounting a heat exchanger within a rear chassis space defined between the second wheel and the fourth wheel.
(179) A method of assembling a mining haul truck, including: a vehicle chassis having a first end portion including the front end of the mining haul truck and a second end portion including a rear of the mining haul truck, a first longitudinal member extending from the first end portion to the second end portion and a second longitudinal member extending from the first end portion to the second end portion, the first longitudinal member and the second longitudinal member defining a vehicle chassis space therebetween; a first wheel coupled to the first longitudinal member at a first forward position; a second wheel coupled to the first longitudinal member at a first rearward position, the first wheel and the second wheel defining a first side saddle therebetween; a third wheel coupled to the second longitudinal member at a second forward position; and a fourth wheel coupled to the second longitudinal member at a second rearward position, the third wheel and the fourth wheel defining a second side saddle therebetween, and the second wheel and the fourth wheel defining a rear chassis space therebetween; wherein the method includes: mounting a fluid tank at the first end portion of the vehicle chassis adjacent to the first end of the vehicle chassis.
(180) The method of Aspect (179), further including mounting a battery module to a power module support frame in the vehicle chassis space.
(181) The method of any one of Aspects (179)-(180), further including mounting a fuel cell module to the vehicle chassis in one of the first side saddle and the second side saddle.
(182) The method of Aspect (181), further including mounting a hydraulic tank to the vehicle chassis in the other of the first side saddle and the second side saddle.
(183) The method of any one of Aspects (179)-(182), further including mounting a heat exchanger to the vehicle chassis in the rear chassis space.
(184) A mining haul truck, including: a vehicle chassis having a first end portion with a first end and a second end portion with a second end, the vehicle chassis including a first longitudinal member extending from the first end to the second end and a second longitudinal member extending from the first end to the second end, the first longitudinal member and the second longitudinal member defining a vehicle chassis space therebetween; a deck supported by the first end portion of the vehicle chassis; and an air inlet assembly mounted to the deck, the air inlet assembly including an air inlet scoop positioned above the deck and an air filter positioned in the air inlet scoop.
(185) The mining haul truck of Aspect (184), further including a fuel cell module mounted to a power module support frame within the vehicle chassis space and coupled to the vehicle chassis.
(186) The mining haul truck of Aspect (185), further including a battery module mounted to the power module support frame in a vertical arrangement with the fuel cell stack so that the fuel cell stack is positioned above the battery module.
(187) The mining haul truck of any one of Aspects (185)-(186), further including a fluid tank mounted to the power module support frame in a vertical arrangement with the fuel cell module so that the fuel cell module is positioned above the battery module.
(188) The mining haul truck of any one of Aspects (185)-(187), wherein the air inlet assembly includes an outlet positioned adjacent to the fuel cell module.
(189) The mining haul truck of any one of Aspects (184)-(188), further including an air pump positioned within a body of the air inlet assembly.
(190) The mining haul truck of any one of Aspects (184)-(189), further including a balance-of-plant module positioned within a body of the air inlet assembly.
(191) The mining haul truck of any one of Aspects (184)-(190), further including a second filter positioned within a body of the air inlet assembly.
(192) The mining haul truck of any one of Aspects (184)-(191), further including an exhaust positioned between a portion of the air inlet assembly and a bottom surface of the deck.
(193) The mining haul truck of any one of Aspects (184)-(192), further including a first wheel mounted to a forward position of the first longitudinal member of the vehicle chassis; a second wheel mounted to a rearward position of the first longitudinal member of the vehicle chassis; a side saddle defined between the first wheel and the second wheel; and a battery module mounted to the vehicle chassis within the side saddle.
(194) The mining haul truck of any one of Aspects (184)-(193), further including: a first wheel mounted to a forward position of the first longitudinal member of the vehicle chassis; a second wheel mounted to a rearward position of the first longitudinal member of the vehicle chassis; a side saddle defined between the first wheel and the second wheel; and a fluid tank mounted to the vehicle chassis within the side saddle.
(195) The mining haul truck of Aspect (194), wherein the fluid tank contains one of methanol and ammonia.
(196) The mining haul truck of Aspect (194), wherein the fluid tank is a hydrogen tank.
(197) The mining haul truck of any one of Aspects (184)-(196), further including a radiator mounted at a first end portion of the vehicle chassis adjacent the first end of the vehicle chassis.
(198) The mining haul truck of Aspect (197), wherein the radiator is hingedly mounted.
(199) The mining haul truck of any one of Aspects (184)-(198), further including a DC/DC system mounted to a power module support frame within the vehicle chassis space and coupled to the vehicle chassis.
(200) The mining haul truck of Aspect (199), further including a first wheel mounted to a forward position of the first longitudinal member of the vehicle chassis; a second wheel mounted to a rearward position of the first longitudinal member of the vehicle chassis; a side saddle defined between the first wheel and the second wheel; and a fuel cell module mounted to the vehicle chassis within the side saddle.
(201) The mining haul truck of any one of Aspects (184)-(200), wherein the deck defines an access panel.
(202) A method of assembling a mining haul truck, the mining haul truck including a vehicle chassis having a first end portion with a first end and a second end portion with a second end, the vehicle chassis including a first longitudinal member extending from the first end to the second end and a second longitudinal member extending from the first end to the second end, the first longitudinal member and the second longitudinal member defining a vehicle chassis space therebetween, the mining haul truck further including a deck supported by the first end portion of the vehicle chassis, the method including: mounting an air inlet assembly to the deck, the air inlet assembly including an air inlet scoop positioned above the deck; and positioning an air filter in the air inlet scoop.
(203) The method of Aspect (202), further including mounting a fuel cell module to a power module support frame coupled to the vehicle chassis within the vehicle chassis space.
(204) The method of Aspect (203), further including mounting a battery module to the power module support frame in a vertical arrangement with the fuel cell module so that the fuel cell module is positioned above the battery module.
(205) The method of any one of Aspects (203)-(204), further including mounting a fluid tank to the power module support frame in a vertical arrangement with the fuel cell module so that the fuel cell module is positioned above the battery module.
(206) The method of any one of Aspects (203)-(205), further including positioning an outlet of the air inlet assembly adjacent to the fuel cell module.
(207) The method of any one of Aspects (202)-(206), further including positioning an air pump within a body of the air inlet assembly.
(208) The method of any one of Aspects (202)-(207), further including positioning a balance-of-plant module within a body of the air inlet assembly.
(209) The method of any one of Aspects (202)-(208), further including positioning a second filter within a body of the air inlet assembly.
(210) The method of any one of Aspects (202)-(209), further including positioning an exhaust between a portion of the air inlet assembly and a bottom surface of the deck.
(211) The method of any one of Aspects (202)-(210), wherein the mining haul truck further includes a first wheel mounted to a forward position of the first longitudinal member of the vehicle chassis, a second wheel mounted to a rearward position of the first longitudinal member of the vehicle chassis, and a side saddle defined between the first wheel and the second wheel, the method further including: mounting a battery module to the vehicle chassis within the side saddle.

1(212) The method of any one of Aspects (202)-(211), wherein the mining truck further includes a first wheel mounted to a forward position of the first longitudinal member of the vehicle chassis, a second wheel mounted to a rearward position of the first longitudinal member of the vehicle chassis, and a side saddle defined between the first wheel and the second wheel, the method further including: mounting a fluid tank to the vehicle chassis within the side saddle.
(213) The method of Aspect (212), wherein the fluid tank contains one of methanol and ammonia.
(214) The method of Aspect (212), wherein the fluid tank is a hydrogen tank.
(215) The method of any one of Aspects (202)-(214), further including mounting a radiator at the first end portion of the vehicle chassis adjacent the first end of the vehicle chassis.
(216) The method of Aspect (215), wherein mounting the radiator includes hingedly mounting the radiator.
(217) The method of any one of Aspects (202)-(216), further including mounting a DC/DC system to a power module support frame coupled to the vehicle chassis within the vehicle chassis space.
(218) The method of Aspect (217), wherein the mining haul truck further includes a first wheel mounted to a forward position of the first longitudinal member of the vehicle chassis, a second wheel mounted to a rearward position of the first longitudinal member of the vehicle chassis, and a side saddle defined between the first wheel and the second wheel, the method further including: mounting a fuel cell module to the vehicle chassis within the side saddle.
(219) The method of any one of Aspects (202)-(218), wherein the deck defines an access panel.
(220) A fuel cell module arrangement, including: a first battery module coupled to a top surface of a power module support frame; a first fuel cell module positioned above the first battery module and having a first connection end facing a first direction; and a first balance-of-plant module coupled to a top surface of the power module support frame adjacent the first battery module, the first balance-of-plant module operably connected to the first connection end of the first fuel cell module.
(221) The fuel cell module arrangement of Aspect (220), further including a second battery module coupled to a bottom surface of the power module support frame.
(222) The fuel cell module arrangement of any one of Aspects (220)-(221), further including a second fuel cell module positioned above the first battery module and having a second connection end facing a second direction.
(223) The fuel cell module arrangement of Aspect (222), wherein the first direction and the second direction are opposite of each other.
(224) The fuel cell arrangement of any one of Aspects (222)-(223), further including a second balance-of-plant module coupled to a top surface of the power module support frame, the second balance-of-plant module operably connected to the second connection end of the second fuel cell module.
(225) The fuel cell module arrangement of Aspect (224), wherein the first balance-of-plant module is coupled to the top surface of the power module support frame corresponding with a first longitudinal half of the power module support frame and the second balance-of-plant module is coupled to the top surface of the power module support frame corresponding with a second longitudinal half of the power module support frame.
(226) The fuel cell module arrangement of any one of Aspects (222)-(225), wherein the first fuel cell module is a plurality of fuel cell modules.
(227) The fuel cell module arrangement of Aspect (226), wherein the plurality of fuel cell modules includes a stacked pair of fuel cell modules.
(228) The fuel cell module arrangement of Aspect (227), wherein the plurality of fuel cell modules includes two stacked pairs of fuel cell modules.
(229) The fuel cell module arrangement of any one of Aspects (226)-(228), wherein the first balance-of-plant module is a plurality of balance-of-plant modules.
(230) The fuel cell module arrangement of Aspect (229), wherein the plurality of balance-of-plant modules includes a stacked pair of balance-of-plant modules.
(231) The fuel cell module arrangement of Aspect (230), wherein the plurality of balance-of-plant modules includes two stacked pairs of fuel cell modules.
(232) The fuel cell module arrangement of any one of Aspects (229)-(231), wherein the first connection end of each fuel cell module of the plurality of fuel cell modules faces a first direction and each balance-of-plant module of the plurality of balance-of-plant modules is arranged on a first longitudinal half of the power module support frame corresponding with the first direction; wherein the fuel cell module arrangement further includes a second plurality of fuel cell modules positioned above the first battery pack module, each fuel cell of the second plurality of fuel cell modules having a second connection end facing a second direction; and a second plurality of balance-of-plant modules coupled on a second longitudinal half of the power module support frame corresponding with the second direction.

What is claimed is:

1. A mining haul truck, comprising:
a vehicle chassis having a first end portion with a first end and a second end portion with a second end, the vehicle chassis comprising a first longitudinal member extending from the first end to the second end and a second longitudinal member extending from the first end to the second end, the first longitudinal member and the second longitudinal member defining a vehicle chassis space therebetween;
a first wheel coupled to the first longitudinal member at a first forward position;
a second wheel coupled to the first longitudinal member at a first rearward position, the first wheel and the second wheel defining a side saddle therebetween;
a third wheel coupled to the second longitudinal member at a second forward position;
a fourth wheel coupled to the second longitudinal member at a second rearward position, the third wheel and the fourth wheel defining a second side saddle therebetween;
a power module support frame coupled to a forward position of the vehicle chassis; and
a first fluid tank positioned within the vehicle chassis space defined by the first longitudinal member and the second longitudinal member and supported by the power module support frame.

2. The mining haul truck of claim 1, further comprising a hydraulic fluid tank positioned in the second side saddle and mounted to the vehicle chassis.

3. The mining haul truck of claim 1, further comprising a battery module positioned within the vehicle chassis space and supported by the power module support frame.

4. The mining haul truck of claim 1, further comprising a battery module positioned within the first end portion of the vehicle chassis on or adjacent to the first end of the vehicle chassis.

5. The mining haul truck of claim 1, further comprising a battery module positioned in one of the first side saddle and the second side saddle and mounted to the vehicle chassis.

6. The mining haul truck of claim 1, further comprising a fuel cell module positioned within the vehicle chassis space adjacent to the first fluid tank.

7. The mining haul truck of claim 1, further comprising a fuel cell module positioned in the first side saddle and mounted to the vehicle chassis.

8. The mining haul truck of claim 1, further comprising a balance-of-plant module positioned within the vehicle chassis space and supported by at least one of the power module support frame and the first fluid tank.

9. The mining haul truck of claim 1, further comprising an air cleaner positioned within the vehicle chassis space and supported by at least one of the power module support frame and the first fluid tank.

10. A mining haul truck, comprising:
a vehicle chassis having a first end portion with a first end and a second end portion with a second end, the vehicle chassis comprising a first longitudinal member extending from the first end to the second end and a second longitudinal member extending from the first end to the second end, the first longitudinal member and the second longitudinal member defining a vehicle chassis space therebetween;
a power module support frame coupled to a forward position of the vehicle chassis;
a first fluid tank positioned within the vehicle chassis space defined by the first longitudinal member and the second longitudinal member and mounted to a lower portion of the power module support frame;
a fuel cell module positioned within the vehicle chassis space and supported by an upper portion of the power module support frame; and
a balance-of-plant module positioned within the vehicle chassis space and supported by the upper portion of the power module support frame.

11. The mining haul truck of claim 10, further comprising:
a first wheel coupled to the first longitudinal member at a first forward position;
a second wheel coupled to the first longitudinal member at a first rearward position, the first wheel and the second wheel defining a side saddle therebetween; and
a battery module positioned within the first side saddle and mounted to the vehicle chassis.

12. The mining haul truck of claim 11, further comprising:
a third wheel coupled to the second longitudinal member at a second forward position;
a fourth wheel coupled to the second longitudinal member at a second rearward position, the third wheel and the fourth wheel defining a second side saddle therebetween;
a hydraulics tank positioned within the second side saddle and mounted to the vehicle chassis; and
a second fluid tank positioned within the second side saddle and mounted to the vehicle chassis.

13. The mining haul truck of claim 12, wherein at least one of the first fluid tank and the second fluid tank is a hydrogen tank.

14. The mining haul truck of claim 12, wherein at least one of the first fluid tank and the second fluid tank contains one of methanol and ammonia.

15. The mining haul truck of claim 10, further comprising a deck supported by the first end portion of the vehicle chassis and an air cleaner supported by the deck.

16. A mining haul truck, comprising:
a vehicle chassis having a first end portion with a first end and a second end portion with a second end, the vehicle chassis comprising a first longitudinal member extending from the first end to the second end and a second longitudinal member extending from the first end to the second end, the first longitudinal member and the second longitudinal member defining a vehicle chassis space therebetween;
a power module support frame positioned within the vehicle chassis space and coupled to the vehicle chassis;
a first battery module supported by the power module support frame;
a first fuel cell module positioned within the vehicle chassis space and supported by the power module support frame in a vertical arrangement with the first battery module so that the first fuel cell module is positioned above the first battery module; and
a first balance-of-plant module positioned on the power module support frame and operably connected to the first fuel cell module.

17. The mining haul truck of claim 16, further comprising a first wheel coupled to the first longitudinal member at a forward position and a second wheel coupled to the first longitudinal member at a rearward position, the first wheel and the second wheel defining a side saddle therebetween; and
a fluid tank positioned within the first side saddle and coupled to the first longitudinal member.

18. The mining haul truck of claim 16, further comprising a second battery module positioned within the vehicle chassis space and supported by the power module support frame.

19. The mining haul truck of claim 18, further comprising:
a second fuel cell module positioned within the vehicle chassis space and supported by the power module support frame in a vertical arrangement with the second battery module so that the second fuel cell module is positioned above the second battery module; and
a second balance-of-plant module positioned within the vehicle chassis space, supported by the power module support frame, and connected to the second fuel cell module.

20. The mining haul truck of claim 18, wherein the first battery module is coupled to a top surface of the power module support frame and the second battery module is coupled to a bottom surface of the power module support frame.
